(19) United States
(12) Patent Application Publication
(10) Pub. No.: US 2018/0302231 A1
(43) Pub. Date: Oct. 18, 2018

(54) METHOD FOR PROCESSING JOB INFORMATION AND ELECTRONIC DEVICE SUPPORTING SAME

(71) Applicant: Samsung Electronics Co., Ltd., Gyeonggi-do (KR)

(72) Inventors: Joo Il SUNG, Seoul (KR); Won Gi CHAE, Gyeonggi-do (KR); Jin Hong JEONG, Gyeonggi-go (KR); Kyung Tae KIM, Gyeonggi-do (KR); Min Woo LEE, Daejeon (KR); Soo Kwan LEE, Seoul (KR); Won Joon CHO, Seoul (KR)

(21) Appl. No.: 15/765,442

(22) PCT Filed: Sep. 30, 2016
(86) PCT No.: PCT/KR2016/010948

§ 371 Date: Apr. 2, 2018

(30) Foreign Application Priority Data
Oct. 2, 2015 (KR) 10-2015-0138991

(51) Int. Cl. H04L 12/18; G06Q 10/10

(52) U.S. Cl. CPC H04L 12/1813; H04W 88/02; G06Q 10/1097

(57) ABSTRACT

An electronic device includes a housing, a display disposed in one surface of the housing, a processor operatively connected to the display, and a memory operatively connected to the processor. The memory stores instructions, when executed, causing the processor to display a chat room, in which a plurality of users participate, in at least part of the display, to display identification information associated with at least one user selected among the plurality of users, in at least part of the chat room, and to display a window associated with job information of the selected at least one user so as to be overlapped with at least part of the chat room, in response to a user input to select the identification information.

### TECHNICAL FIELD

The present disclosure relates to job information processing.

### BACKGROUND ART

An electronic device provides a calendar, a scheduler, or the like. A user may enter job information in a specific date of the calendar.

### DETAILED DESCRIPTION OF THE INVENTION

### Technical Problem

A calendar memo function provided by a conventional electronic device may provide only a function of entering and displaying information. Accordingly, for the purpose of transmitting job information to other users who need to collaborate with each other, a user needs to contact each of other users by phone or e-mail.

Various embodiments may provide a job information processing method that allows job information to be easily shared between collaborative users based on a chat, and an electronic device supporting the same.

### Technical Solution

According to various embodiments of the present disclosure, an electronic device includes a housing, a display disposed in one surface of the housing, a processor operatively connected to the display, and a memory operatively connected to the processor. The memory stores instructions, when executed, causing the processor to display a chat room, in which a plurality of users participate, in at least part of the display, to display identification information associated with at least one user selected among the plurality of users, in at least part of the chat room, and to display a window associated with job information of the selected at least one user so as to be overlapped with at least part of the chat room, in response to a user input to select the identification information.

According to various embodiments of the present disclosure, a job information processing method includes displaying a chat room, in which a plurality of users participate, in at least part of a display, displaying identification information associated with at least one user selected among the plurality of users, in at least part of the chat room, and displaying a window associated with job information of the selected at least one user so as to be overlapped with the at least part of the chat room, in response to a user input to select the identification information.

Other aspects, advantages, and salient features of the disclosure will become apparent to those skilled in the art from the following detailed description, which, taken in conjunction with the annexed drawings, discloses various embodiments of the present disclosure.

### Advantageous Effects of the Invention

Various embodiments may allow job information to be shared and transmitted easily and may provide an environment in which a new job is generated and directed easily.

In addition, various embodiments may allow information associated with job progress or the like to be checked immediately and effectively.

### DESCRIPTION OF THE DRAWINGS

FIG. 1 is a block diagram illustrating an electronic device operating environment associated with job information processing, according to an embodiment.

FIG. 2 is a block diagram illustrating an example of a processor configuration associated with job information processing, according to an embodiment.

FIG. 3 is a flowchart illustrating a job information processing method, according to an embodiment.

FIG. 4 is a flowchart illustrating a job information processing method based on a chat room, according to an embodiment.

FIG. 5 is a flowchart illustrating a job information processing method associated with job generation and job direction, according to an embodiment.

FIG. 6 illustrates an example of a basic screen interface associated with job information processing, according to an embodiment.

FIG. 7A is a view illustrating an example of a screen interface associated with job generation and job view, according to an embodiment.

FIG. 7B is a view illustrating an example of a screen interface associated with view of chat room detail information, according to an embodiment.

FIG. 8 is a view illustrating an example of a screen interface associated with view of job information about all chat rooms, according to an embodiment.

FIG. 9 is a view illustrating an example of a screen interface associated with calendar information generation, according to an embodiment.

FIG. 10 is a view illustrating an example of a screen interface associated with sharing of calendar information, according to an embodiment.

FIG. 11 is a view illustrating an example of a screen interface associated with sharing of to-do information, according to an embodiment.

FIG. 12 is a view illustrating another example of a screen interface associated with sharing of to-do information, according to an embodiment.

FIG. 13 is a view illustrating an example of a screen interface associated with sharing of file information, according to an embodiment.

FIG. 14 is a view illustrating an example of a screen interface associated with calendar information direct transmission, according to an embodiment.

FIG. 15 is a view illustrating an example of a screen interface associated with to-do information direct transmission, according to an embodiment.

FIG. 16 is a view illustrating an example of a screen interface associated with file information direct transmission, according to an embodiment.

FIG. 17 is a view illustrating an example of a screen interface associated with file view, according to an embodiment.

FIG. 18 is a view illustrating an example of a screen interface associated with information linkage processing, according to an embodiment.

FIG. 19 is a view illustrating an example of a screen interface associated with interest information processing, according to an embodiment.

FIG. 20 is a view illustrating an example of a screen interface associated with job information processing according to user context, according to an embodiment.

FIG. 21 is a view illustrating an example of a screen interface associated with making minutes, according to an embodiment.

FIG. 22 is a view illustrating an example of a screen interface associated with minute generation, according to an embodiment.

FIG. 23 is a view illustrating an example of a screen interface associated with search processing, according to an embodiment.

FIG. 24 is a view illustrating an example of a screen interface associated with to-do information arrangement change, according to an embodiment.

FIG. 25 is a view illustrating an example of a screen interface associated with a chat function operation based on voice information, according to an embodiment.

FIG. 26 is a view illustrating an example of a screen interface associated with a job information display in a wearable device, according to an embodiment.

FIG. 27 illustrates a block diagram of an electronic device, according to an embodiment.

FIG. 28 is a block diagram of a program module, according to an embodiment.

### BEST MODE

Hereinafter, various embodiments of the present disclosure may be described with reference to accompanying drawings. Accordingly, those of ordinary skill in the art will recognize that modifications, equivalents, and/or alternatives on the various embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of this disclosure may not be limited to the above-described electronic devices and may include other electronic devices and new electronic devices according to the development of technologies.

Hereinafter, electronic devices according to various embodiments will be described with reference to the accompanying drawings. In this disclosure, the term “user” may refer to a person who uses an electronic device or may refer to a device (e.g., an artificial intelligence electronic device) that uses the electronic device.

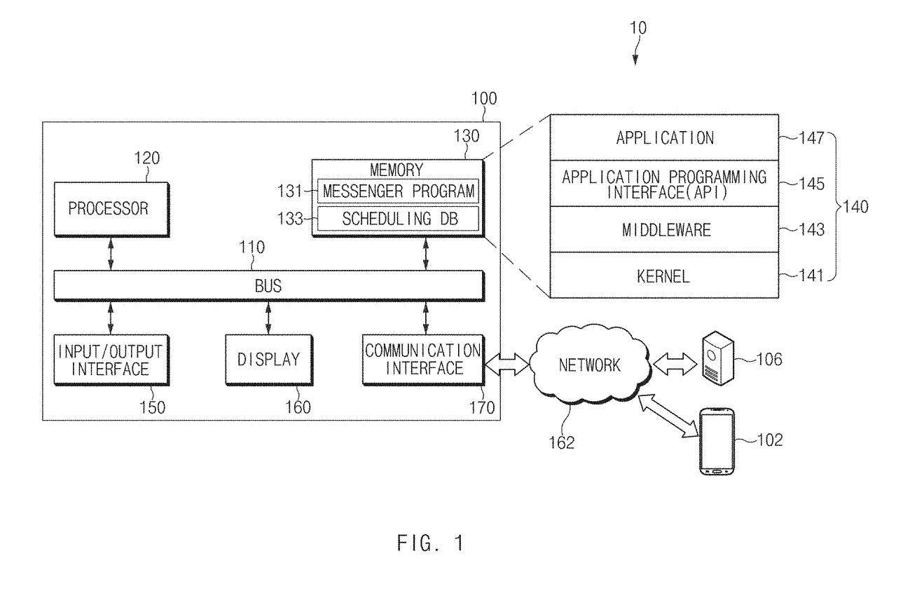

FIG. 1 is a block diagram illustrating an electronic device operating environment associated with job information processing, according to an embodiment.

Referring to FIG. 1, an electronic device operating environment 10 may support job information transfer between an electronic device 100 and an external electronic device 102 through a chat channel, thereby allowing job information to be shared in real time.

The external electronic device 102 may establish a chat channel with the electronic device 100 through a network 162. The external electronic device 102 may transmit or receive the job information to or from the electronic device 100 based on the chat channel and may store and display the job information. The external electronic device 102 may support a function substantially the same as or similar to the function of the electronic device 100. According to an embodiment, the external electronic device 102 may install a messenger program for processing the job information and may establish a chat channel through the network 162. According to various embodiments, the messenger program for processing the job information may be provided by a server 106. Each of the external electronic device 102 and the electronic device 100 may install the messenger program and may access the server 106 through the network 162.

According to an embodiment, the server 106 may provide the messenger program for processing the job information to the external electronic device 102 or the electronic device 100. The server 106 may establish a communication channel with the electronic device 100 and the external electronic device 102 that install the messenger program. For example, the server 106 may establish a chat channel between the external electronic device 102 and the electronic device 100. The server 106 may store and manage chat information or job information that is provided by the external electronic device 102 and the electronic device 100. The server 106 may share the stored job information or chat information with the external electronic device 102 and the electronic device 100. In the case where the external electronic device 102 and the electronic device 100 operate the messenger program directly establishing the chat channel, the operation of the server 106 may be skipped.

The electronic device 100 may establish the chat channel with the external electronic device 102 through the network 162. The electronic device 100 may provide a basic execution screen, a chat screen, and the like that are based on the chat channel. For example, the chat room may include a title area, a dialog area, an input window, and the like. The electronic device 100 may support the opening and operation of a plurality of chat rooms. The electronic device 100 may share job information through at least one chat room, may generate job information, or may transmit the generated job information to an electronic device (e.g., the external electronic device 102) of a specific user (or a participant). For example, the job information may include at least one of calendar information, to-do information, or file information.

The above-described electronic device 100 may include a bus 110, a processor 120, a memory 130, an input/output interface 150, a display 160, and a communication interface 170. According to an embodiment, the electronic device 100 may not include at least one of the above-described elements or may further include other element(s). Alternatively, the electronic device 100 may include a housing that surrounds or contains at least part of the above-described elements.

For example, the bus 110 may interconnect the above-described elements 110 to 170 and may include a circuit for conveying communications (e.g., a control message and/or data) among the above-described elements.

The processor 120 may include one or more of a central processing unit (CPU), an application processor (AP), or a communication processor (CP). The processor 120 may perform, for example, data processing or an operation associated with control or communication of at least one other element(s) of the electronic device 100. At least part of the processor 120 may be implemented based on at least part of hardware or software. Alternatively, at least one hardware processor may constitute the processor 120.

According to various embodiments, the processor 120 may support job information processing of the electronic device 100. For example, the processor 120 may establish a chat channel with the external electronic device 102, may share the stored job information, may generate job information, or may transmit the job information. In addition, the processor 120 may support the writing of minutes associated with a chat room based on the chat channel, the processing of job information shared in at least one chat room or interest information associated with the selection of chat information, search processing of a search word according to a user input, or the like.

The memory 130 may store program or data associated with job information processing. According to an embodiment, the memory 130 may store a messenger program 131 and a scheduling DB 133. For example, the messenger program 131 may include a chat program for processing job information. The messenger program 131 may include at least one of an instruction set (or a class, a template, a routine, a function, or the like) associated with a chat transmitting and receiving function, an instruction set associated with a job information processing function, an instruction set associated with a minute processing function, an instruction set associated with an interest information processing function, or an instruction set associated with a search processing function. The scheduling DB 133 may include data associated with job information processing. For example, the scheduling DB 133 may include job information including calendar information (or schedule information), to-do information, file information, or the like. The calendar information may include a date and schedule information registered in the date. The to-do information may include memo information, due date information, related person information, or the like. The file information may include information about a file and a writer of the file, or the like. According to various embodiments, at least one meeting record, interest information, or the like generated by the minute processing function may be stored in the scheduling DB 133.

The above-described memory 130 may include a volatile and/or nonvolatile memory. The memory 130 may store instructions or data associated with at least one other element(s) of the electronic device 100. According to an embodiment, the memory 130 may store software and/or a program 140. The program 140 may include, for example, a kernel 141, a middleware 143, an application programming interface (API) 145, and/or an application program (or an application) 147. At least a part of the kernel 141, the middleware 143, or the API 145 may be called an “operating system (OS)”.

The kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete components of the electronic device 100 so as to control or manage system resources.

The middleware 143 may perform a mediation role such that the API 145 or the application program 147 communicates with the kernel 141 to exchange data.

Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 100, to at least one of the application program 147. For example, the middleware 143 may process the one or more task requests according to the priority assigned to the at least one, which makes it possible to perform scheduling or load balancing on the one or more task requests.

For example, the API 145 may be an interface through which the application program 147 controls a function provided by the kernel 141 or the middleware 143, and may include, for example, at least one interface or function (e.g., an instruction) for a file control, a window control, image processing, a character control, or the like.

The application 147 may include a program described to perform a designated function. For example, the application 147 may include a messenger application corresponding to a messenger program for processing job information.

The I/O interface 150 may transmit a command or data, input from a user or another external device, to other element(s) of the electronic device 100. Furthermore, the input/output interface 150 may output a command or data, received from other component(s) of the electronic device 100, to a user or another external device. According to various embodiments, the input/output interface 150 may include an input device, for example, a touch panel, a physical key, an optical key, a keypad, or the like. According to an embodiment, the input/output interface 150 may generate an input event (e.g., a touch event or a key input event, a virtual key input event, or the like) associated with an information input, a search word input, new job information generation, job information sharing, or the like upon executing a chat function in response to a user input. The generated input event is transmitted to the processor 120 and may be processed by using an instruction for executing a related function.

According to various embodiments, the input/output interface 150 may include an audio input/output device such as a speaker, a receiver, a earphone, a microphone, or the like. According to an embodiment, the input/output interface 150 may output an effect sound associated with the generation, the transmission, the sharing, and the like of the job information or may output an effect sound corresponding to the generation and the sharing of minutes, search processing, the registration and viewing of interest information, or the like. The effect sound output may be omitted depending on settings.

The display 160 may include, for example, a liquid crystal display (LCD), a light-emitting diode (LED) display, an organic LED (OLED) display, or a microelectromechanical systems (MEMS) display, or an electronic paper display. The display 160 may display, for example, various kinds of contents (e.g., text, an image, a video, an icon, a symbol, or the like) to a user. The display 160 may include a touch screen and may receive, for example, a touch, gesture, proximity, or hovering input using an electronic pen or a portion of a user's body. According to various embodiments, the display 160 may output a basic execution screen a chat room screen, or the like associated with the messenger program 131. Furthermore, the display 160 may output a job information processing screen capable of being provided through a basic execution screen, a job information processing screen capable of being provided through a chat room screen, or the like. Furthermore, the display 160 may output at least one of a minute processing screen, an interest information processing screen, a search processing screen in response to a user input.

The communication interface 170, for example, may set a communication between the electronic device 100 and an external device (e.g., the external electronic device 102, or a server 106). For example, the communication interface 170 may be connected to the network 162 through wireless or wired communication to communicate with the external device. The wireless communication may include at least one of, for example, a long-term evolution (LTE), an LTE Advance (LTE-A), a code division multiple access (CDMA), a wideband CDMA (WCDMA), a universal mobile telecommunication system (UMTS), a wireless broadband (WiBro), a global system for mobile communications (GSM), or the like, as a cellular communication protocol. In addition, the wireless communication may include, for example, the short range communication. The short range communication may include at least one of, for example, wireless fidelity (Wi-Fi), Bluetooth, near field communication (NFC), a global navigation satellite system (GNSS), or the like. The GNSS may include at least one of a global positioning system (GPS), a global navigation satellite system (Glonass), a Beidou Navigation Satellite System (hereinafter referred to as “Beidou”), or a European global satellite-based navigation system (Galileo). Hereinafter, “GPS” and “GNSS” may be used interchangeably in the present disclosure. The wired communication may include at least one of, for example, a universal serial bus (USB), a high definition multimedia interface (HDMI), a recommended standard-232 (RS-232), a plain old telephone service (POTS), or the like. The network 162 may include telecommunications networks, for example, at least one of a computer network (e.g., LAN or WAN), an Internet, or a telephone network.

According to various embodiments, the communication interface 170 may support chat channel establishment with an external electronic device. For example, the chat channel may be established through a short range communication channel, a communication channel based on a base station, or the like. Under control of a user, the communication interface 170 may transmit job information stored in the electronic device 100 to the external electronic device 102 or may receive job information that the external electronic device 102 transmits. Moreover, the communication interface 170 may support transmitting or receiving minutes, transmitting or receiving chat information, or the like.

According to an embodiment, the server 106 may include a server or a group of two or more servers. According to various embodiments, all or a part of operations that the electronic device 100 will perform may be executed by another or plural electronic devices (e.g., the electronic device 102 or the server 106). According to an embodiment, in the case where the electronic device 100 executes any function or service automatically or in response to a request, the electronic device 100 may not perform the function or the service internally, but, alternatively or additionally, it may request at least a portion of a function associated with the electronic device 100 from other devices (e.g., the electronic device 102 or the server 106). The other electronic device (e.g., the electronic device 102 or the server 106) may execute the requested function or additional function and may transmit the execution result to the electronic device 100. The electronic device 100 may provide the requested function or service by processing the received result as it is, or additionally. To this end, for example, cloud computing, distributed computing, or client-server computing may be used.

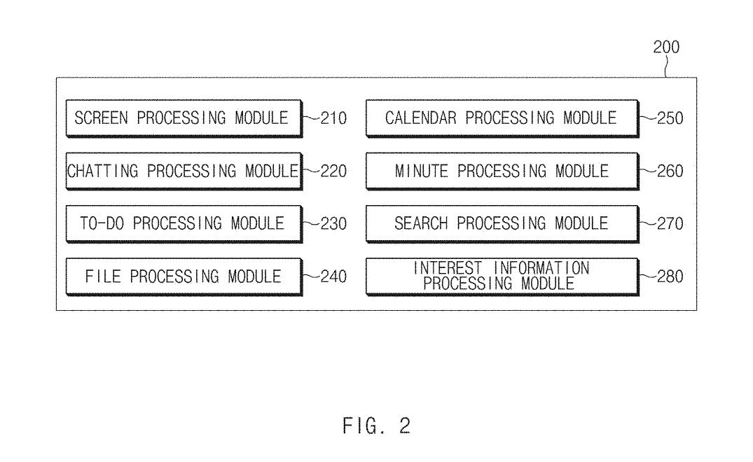

FIG. 2 is a block diagram illustrating an example of a processor configuration associated with job information processing, according to an embodiment.

Referring to FIG. 2, a processor 200 (e.g., the processor 120) may include at least one of a screen processing module 210, a chatting processing module 220, a to-do processing module 230, a file processing module 240, a calendar processing module 250, a minute processing module 260, a search processing module 270, and an interest information processing module 280.

If a messenger application execution request is generated, the screen processing module 210 may output a basic execution screen associated with a messenger function to the display 160. The screen processing module 210 may output a chat information item, a to-do information item, a file information item, and a calendar information item in a basic execution screen. If each of the items is selected, the screen processing module 210 may make a request for function processing corresponding to the selected item to the corresponding module.

The chatting processing module 220 may perform chat information processing. For example, the chatting processing module 220 may output other user connection information in the form of a list or the like. If an input event to request chat room generation occurs after the selection of the other user connection information, the chatting processing module 220 may generate a chat room associated with the selected other user connection information. The chatting processing module 220 may process a text or the like entered during a chat room operation. In addition, the chatting processing module 220 may output the text that an external electronic device transmits, in the chat room screen. According to an embodiment, if a chat information item is selected, the chatting processing module 220 may output at least one chat room list. If a specific item is selected in the chat room list, the chatting processing module 220 may output the chat room screen corresponding to the selected chat room item. According to various embodiments, upon outputting the chat room screen, the chatting processing module 220 may collect and output other user context information. For example, the chatting processing module 220 may make a request for location information, local time information, or the like to the external electronic device connected to the chat room. The chatting processing module 220 may include and output the collected location information and local time information in the other user item (e.g., a speech bubble, an icon, or the like).

The to-do processing module 230 may process to-do information in the job information. For example, the to-do processing module 230 may output a personal to-do information list associated with the selected other user item. The to-do processing module 230 may generate to-do information to be provided to the selected other user item, in response to a user input. The to-do processing module 230 may output a group to-do information list associated with the corresponding chat room. Moreover, the to-do processing module 230 may output the entire to-do information list in the basic execution screen. For example, the entire to-do information list may be classified and output for each date or for each chat room. In the case where the entire to-do information list is not output in one screen because the entire to-do information list has the specified number or more, items that are not yet output may be output by a scroll function.

The file processing module 240 may perform file information processing. For example, the file processing module 240 may transmit or receive a file through a chat room. For example, the file processing module 240 may output the stored file information list to the electronic device 100 in response to a user input. The file processing module 240 may upload the selected file information from a file information list onto the selected chat room. According to various embodiments, if a user input associated with file information reception uploaded onto the specific chat room is generated, the file processing module 240 may receive and store the file information. The file processing module 240 may provide list information of the transmitted file or the received files. Furthermore, the file processing module 240 may provide the group file list that is transmitted or received in the chat room. The group file list may be overlaid and output in the chat room. According to various embodiments, the file processing module 240 may output a file list associated with all the chat rooms. At this time, the file processing module 240 may output a list of files based on the order of file lists recently transmitted and received or based on the order of chat rooms.

The calendar processing module 250 may perform calendar information processing. For example, if the calendar information item is selected, the calendar processing module 250 may output calendar information in the basic execution screen or in a specific chat room screen. In this operation, the calendar processing module 250 may output calendar information including to-do information having date information in association with the specific chat room. Alternatively, the calendar processing module 250 may output the calendar information including to-do information having date information in association with all the chat rooms. Alternatively, the calendar processing module 250 may output the calendar information in which the to-do information is entered based on today, this week, or this month. The calendar processing module 250 may display a date, on which to-do information is present, from among date values included in the calendar information to be different from a value of each of other dates. Furthermore, the calendar processing module 250 may provide (e.g., display a list in a display) to-do information, which is included today, this week, or this month, to the list.

In response to a user input, the calendar processing module 250 may share to-do information included in the calendar information, in a chat room or may transmit the to-do information to other users.

The minute processing module 260 may generate, store, and share minutes. Upon operating a chat room, the minute processing module 260 may generate content created during a specified period as minutes in response to a user input. For example, the minute processing module 260 may automatically generate minutes at a specific period (e.g., every one hour or every one day) after the start of the meeting or after the end of the meeting (e.g., in the case where there is no dialog input during a specified time). According to various embodiments, if an input event to request generating minutes occurs, the minute processing module 260 may generate minutes in response to a user input.

According to an embodiment, the minute processing module 260 may select a word, which has the specific frequency or more or the highest frequency, in the corresponding chat room to write the word as the title of minutes, and may include the transmitted or received dialog, file information, or the like to generate minutes. According to an embodiment, the minute processing module 260 may include information of the generation, revision, deletion, complete processing, review, reviewed schedule, to-do, file, or the like of the corresponding chat room to generate minutes. The minute processing module 260 may share the generated minutes in the corresponding chat room. Even though a chat room is temporarily closed, in the case where the chat room is maintained in a chat room list of the basic execution screen, the minute processing module 260 may store and manage the minutes in a memory. If the chat room is closed, the minute processing module 260 may delete relevant minutes or may transmit the relevant minutes to a specified electronic device.

If a search word associated with job information is entered, the search processing module 270 may output search information corresponding to the search word or may output a function item, in a chat function. For example, the search processing module 270 may output relevant information or web search-based relevant information among pieces of information stored in the electronic device 100 in association with the input search word. According to various embodiments, when the search word is entered, the search processing module 270 may output items of a function, which is associated with job information processing, from among functions associated with the search word. For example, the function item may include a minute recording function, a to-do information generating or sharing function, a file information sharing function, a calendar information recording function, or the like.

The interest information processing module 280 may process items, which is selected as interest information, from among at least one dialog item, at least one to-do information, or at least one or more pieces of file information that are selected from the chat room or the like. According to an embodiment, the interest information processing module 280 may provide (e.g., output a list in a display) a chat room interest information list obtained by collecting pieces of interest information selected from the chat room or the entire interest information list obtained by collecting pieces of interest information selected from all chat rooms.

According to various embodiments, an electronic device according to an embodiment may include a housing, a display disposed in one surface of the housing, a processor operatively connected to the display, and a memory operatively connected to the processor. The memory may store instructions, when executed, causing the processor to display a chat room, in which a plurality of users participate, in at least part of the display and to display a window associated with job information of the selected at least one user so as to be overlapped with at least part of the chat room, in response to the selection of identification information associated with one user of the plurality of users.

According to various embodiments, an electronic device includes a housing, a display disposed in one surface of the housing, a processor operatively connected to the display, and a memory operatively connected to the processor. The memory stores instructions, when executed, causing the processor to display a chat room, in which a plurality of users participate, in at least part of the display, to display identification information associated with at least one user selected among the plurality of users, in at least part of the chat room, and to display a window associated with job information of the selected at least one user so as to be overlapped with at least part of the chat room, in response to a user input to select the identification information.

According to various embodiments, the instructions may further cause the processor to generate new job information of the at least one user in response to another user input; and to register the new job information as at least part of the job information of the at least one user.

According to various embodiments, the instructions may further cause the processor to activate or deactivate an area, which is associated with new job information and which is capable of generating the new job information on a window, depending on a rating or settings of the at least one user.

According to various embodiments, the instructions may further cause the processor to register the job information of the at least one user as job information of a group of the plurality of users in response to another user input.

According to various embodiments, the instructions may further cause the processor to display the job information of the at least one user in the at least part of the chat room in response to the another user input.

According to various embodiments, the memory may store interest information of a user of the electronic device. The instructions may further cause the processor to store a list or job information selected from a dialog list displayed in the chat room or the job information of the at least one user, as at least part of the interest information.

According to various embodiments, the electronic device may further include a communication circuit. The instructions may further cause the processor to transmit a request to register job information selected from the job information of the at least one user as job information of at least another user among the plurality of users, to an external device by using the communication circuit in response to another user input.

According to various embodiments, the instructions may further cause the processor, if at least one condition associated with the chat room satisfies a specified condition, to transmit the request to the external device.

According to various embodiments, the at least one condition may include whether the another user input is received within a time of a specified range. The instructions may further cause the processor, if the another user input is received within the time of the specified range, to transmit the request to the external device, and, if the another user input is received out of the time of the specified range, to display a notification associated with impossibility of the request so as to be overlapped with the at least part of the chat room.

According to various embodiments, the job information may include at least one of schedule information, to-do information, or file information.

According to various embodiments, the memory may include instructions, when executed, causing the processor to generate new job information of the selected user depending on a specified input event (e.g., another user input or a user input of the electronic device) and to register the new job information as new job information of the selected user.

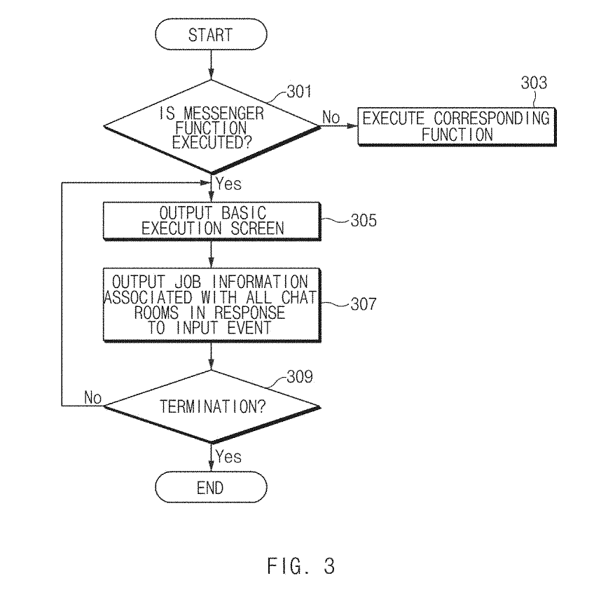

FIG. 3 is a flowchart illustrating a job information processing method, according to an embodiment.

Referring to FIG. 3, in the job information processing method, if an event (e.g., a user input event, a scheduling event, an event received in association with an external electronic device or the like) occurs, in operation 301, the processor 120 (or the processor 200) of the electronic device 100 may determine whether the corresponding event is an event associated with messenger function execution. If the corresponding event is not an event associated with messenger function execution, in operation 303, the processor 120 may execute a function corresponding to a type of an event. For example, the processor 120 may play a file, may receive a web page to output the web page, or may process a call function, depending on the type of an event.

If an event associated with messenger function execution occurs, in operation 305, the electronic device 100 may output a basic execution screen in the display 160. For example, the basic execution screen may be a chat basic screen set by the messenger program 131. For example, the basic execution screen may include at least one chat room list. Alternatively, in the case where a chat room list is not yet generated, the electronic device 100 may display at least one or more items associated with a chat function, for example, other user connection information items. After the selection of the other user connection information, if an event to request chat room generation occurs, the processor 120 may generate a chat room. In this operation, the processor 120 may register the generated chat room list in the basic execution screen.

In operation 307, the processor 120 may output job information associated with all chat rooms in response to an input event. According to an embodiment, the basic execution screen may include a job information area including a chat item, a calendar item, a to-do item, and a file item. The chat item may be configured to provide other user connection information, information about the generated chat room, or the like. When an input event to select the chat item occurs, the processor 120 may output a screen for transmitting/receiving chat information. The calendar item may be configured to provide a date value, calendar information entered on the date, and the like. The information provided from the calendar item may be to-do information set in association with the chat room. When an event to select the calendar item occurs, the processor 120 may output a calendar in which pieces of to-do information generated in all chat rooms is registered for each date. The to-do item may be configured to display at least one to-do information set in association with at least one chat room. According to an embodiment, if an event to select the to-do item occurs, the processor 120 may output pieces of to-do information set in all chat rooms, in the form of a list. The file item may be configured to display at least one file information associated with at least one chat room. According to an embodiment, upon selecting the file item, the processor 120 may collect pieces of file information transmitted or received in all chat rooms and may display the collected pieces of file information depending on specific criteria. For example, the processor 120 may display pieces of file information transmitted or received for each chat room or may display pieces of file information in order of date.

In operation 309, the processor 120 may determine whether an event associated with the function termination occurs. If the event associated with the function termination occurs, the processor 120 may terminate a function. If the event associated with the function termination does not occur, the processor 120 may branch to operation 305 and may perform the following operation again.

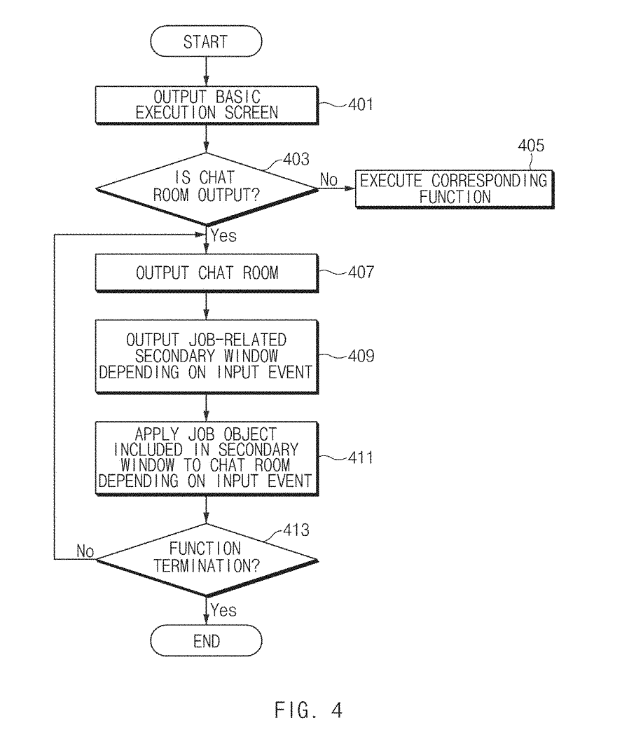

FIG. 4 is a flowchart illustrating a job information processing method based on a chat room, according to an embodiment.

Referring to FIG. 4, in association with the job information processing method based on a chat room, in operation 401, the processor 120 (or the processor 200) of the electronic device 100 may output a basic execution screen. For example, if an event associated with the execution of a messenger application or a chat application occurs, the processor 120 may output a basic screen associated with the execution of the corresponding function. In this operation, the processor 120 may output at least one chat room list. Alternatively, the processor 120 may process a chat room generating function.

If the event occurs, in operation 403, the processor 120 may determine whether the event is an event to request a chat room output. In the case where the event is not the event to request a chat room output, in operation 405, the processor 120 may execute a function corresponding to a type of the corresponding event. For example, the processor 120 may display a to-do information list, calendar information, file information, or the like that is provided from the basic execution screen, depending on the type of an event.

If the event to request a chat room output occurs, in operation 407, the processor 120 may output (e.g., output a chat room in a display) a chat room (e.g., a first user interface). For example, the chat room may include identification information of a user and identification information of other users. Furthermore, if there is a previous conversation history, the chat room may output the previous conversation lists. The chat room may include an input window. After a text is entered through an input window, if the transmission is requested, the input text may be shared in a chat room.

In operation 409, the processor 120 may output a job-related secondary window (or a second user interface) depending on an input event. For example, the job-related secondary window may include a calendar information secondary window, a to-do information secondary window, a file information secondary window, or the like. The job-related secondary window may be at least partly overlaid on a chat room and may be displayed. The job-related secondary window may include at least one job object. For example, the job object may include a display object corresponding to calendar information, to-do information, file information, or the like.

In operation 411, the processor 120 may apply a job object selected from the secondary window to a chat room depending on an input event. For example, the processor 120 may transmit at least one of calendar information, to-do information, or file information, which corresponds to the job object, to share the at least one in the corresponding chat room. Alternatively, the processor 120 may transmit information corresponding to the job object to a specified user among other users in a chat room, in response to a user input. According to an embodiment, the processor 120 may register the job object selected from a to-do information list of the specified user among the other users. In this regard, the processor 120 may transmit a request message for job object registration to an electronic device corresponding to other user(s).

In operation 413, the processor 120 may determine whether an event associated with the function termination occurs. If the event associated with the function termination does not occur, the processor 120 may branch to operation 407 and may perform the following operation again.

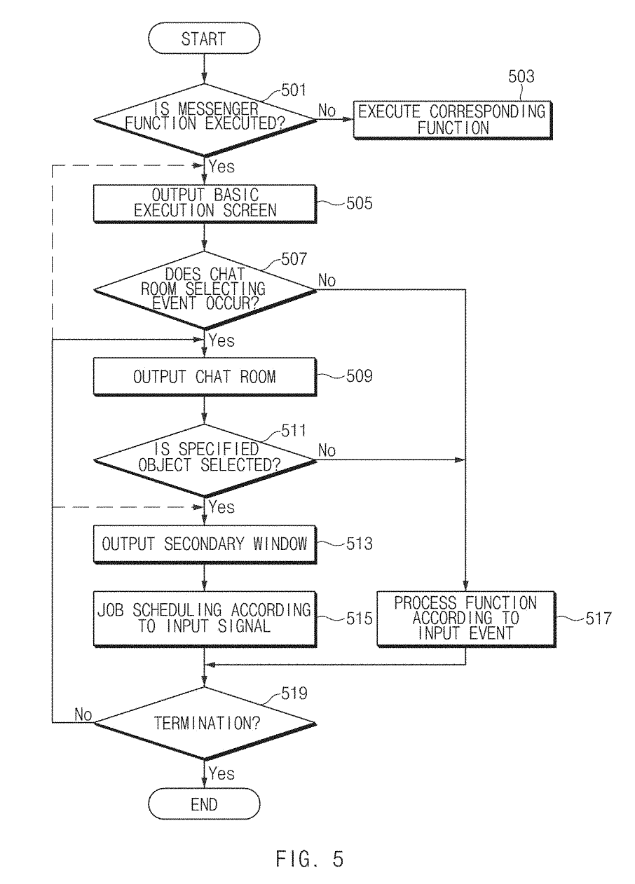

FIG. 5 is a flowchart illustrating a job information processing method associated with job generation and job direction, according to an embodiment.

Referring to FIG. 5, in association with the job information processing method, if an event occurs, in operation 501, the processor 120 (or the processor 200) may determine whether the event is an event associated with the execution of a messenger function. If an event that is not associated with the execution of the messenger function occurs, in operation 503, the processor 120 may execute a function according to a type of the event.

If the event associated with the execution of the messenger function occurs, in operation 505, the processor 120 may output a basic execution screen. For example, the basic execution screen may include at least one chat room list. Alternatively, the basic execution screen may output other user information (e.g., other user identification information) associated with the generation of a chat room.

In operation 507, the processor 120 may determine whether a chat room selecting event occurs. Alternatively, the processor 120 may determine whether an event to request chat room generation occurs. If the chat room selecting event occurs, in operation 509, the processor 120 may output a chat room. For example, the chat room may include at least one object corresponding to identification information of a user, identification information of other user(s), a dialog list, an input window, or the like.

In operation 511, the processor 120 may determine whether an event associated with the selection of a specified object occurs. For example, the specified object may include other user identification information. If an event to select the specified object occurs, in operation 513, the processor 120 may output a secondary window (or a job window). According to an embodiment, if a specified event (e.g., a long press event or the like) to select the other user identification information occurs, the processor 120 may output a secondary window for generating to-do information.

In operation 515, the processor 120 may perform job scheduling according to an input signal. For example, the processor 120 may set title information associated with to-do information, due date information of the to-do information, or the like in response to a user input. The processor 120 may allow the set job information to be included in job information of other user(s) corresponding to the specified object. In this regard, the processor 120 may transmit, to an electronic device of other user(s), a message for requesting the electronic device of other user(s) to register the generated job information (e.g., new to-do information) in job information of other user(s). In the case where the electronic device of other user(s) receives the corresponding message and registers the new job information, the processor 120 may receive a response message corresponding to the new job information from the electronic device of other user(s) to output the response message to the chat room.

If the event that is not associated with the selection of a chat room occurs in operation 507 or if the event that is not associated with the selection of a specified object occurs in operation 511, in operation 517, the processor 120 may process a function according to an input event. For example, the processor 120 may process a dialog input of a text or the like depending on a type of the input event. Alternatively, the processor 120 may process a file information sharing function depending on the type of the input event.

In operation 519, the processor 120 may determine whether an event associated with the function termination occurs. If an event associated with the function termination does not occur, the processor 120 may branch to various operation states depending on a previous processing state or the like. For example, if an event to return to a basic execution screen outputting state occurs without a chat room selecting event, the processor 120 may branch to operation 505. According to various embodiments, if an event associated with specific chat function processing occurs without the specified object selection, the processor 120 may branch to operation 509. According to various embodiments, in the case where an input signal associated with job scheduling is not terminated, the processor 120 may branch to operation 513.

According to various embodiments, if an input event to touch identification information of a first user participating in a chat room occurs, the electronic device 100 may display a window including the to-do information, schedule, punctuality, location, or the like of the first user. Alternatively, in a procedure of displaying a dialog area of a chat room, the electronic device 100 may display the to-do information, schedule, punctuality (e.g., business trip, office attendance, meeting, or the like), location, or the like in an area adjacent to the identification information of each user. According to various embodiments, the electronic device 100 may display a dialog, user identification information, or the like of each of users participating in the chat room, depending on a specified condition or may omit the displaying of the dialog, the user identification information, or the like. Alternatively, the electronic device 100 may display the dialog, the user identification information, or the like of each of users in a specified color. For example, the electronic device 100 may display information (e.g., a dialog list, user identification information, or the like) about a user depending on a chat room operating context (e.g., a state where electronic devices of current participants are used, the case where an electronic device of a participant is at a specified location, or the case where current time is within a specified time period (e.g., specified business hours)) of users. In the case where the chat room operating context of users does not satisfy a specified condition, the electronic device 100 may display user identification information, a dialog list, or the like blurredly or in a specified color.

According to various embodiments, the electronic device 100 may display to-do information associated with a specific user or a chat room in a dialog area in response to the occurrence of a specified event (e.g., drag and drop) to allow all participants to verify the to-do information. According to various embodiments, the electronic device 100 may block a dialog input while a secondary window that is at least partly overlapped with a dialog area of a chat room is output on a dialog area of a chat room and may allow the dialog input to be entered in a state where the secondary window is removed.

According to various embodiments, in the case where to-do information is registered in the dialog area in the sharing form, the electronic device 100 may register the to-do information as group to-do information of participants participating in a chat room. After linking participants to pieces of group to-do information, the electronic device 100 may display whether tasks of participants belonging to a group are completed, whether the task of the whole group is completed, or the like.

According to various embodiments, the electronic device 100 may display to-do information, a schedule, or the like in a dialog area adjacent to the identification information of each user. Herein, in the case where the number of tasks, schedules, or the like is greater than a specified number, the electronic device 100 may display a text or an image indicating to-do, the schedule, or the like in a specific color (e.g., red); in the case where the number is less than the specified number, the electronic device 100 may display the text or the image in a color (e.g., green) different from the specific color. The electronic device 100 may display the number of tasks, schedules, or the like in the numerical form.

According to various embodiments, the electronic device 100 may provide (provide the file to a separate list screen) a file, which is transmitted or received in a chat room, as list information. Furthermore, the electronic device 100 may display information (e.g., a chat room title) about each chat room with respect to files, which are transmitted or received in various chat rooms. If a specific file update occurs, the electronic device 100 may automatically provide a notification to each chat room associated with the file update. The electronic device 100 may allow specific files in a file list to be filtered depending on a specified condition (viewing, receiving, transmitting, designating, favorites, or the like). The electronic device 100 may provide a dash board for displaying relevant to-do or the like in a chat room. Furthermore, the electronic device 100 may display to-do of participants in a chat room, the start time of to-do, the time remaining until the target time required to complete the to-do based on the current time, the time remaining until the time required to participate in a chat room based on the current time, or the like. Furthermore, the electronic device 100 may display, in a specific area of the chat room or a specific area of the basic execution screen, tasks to be performed within hours or on the same day; if the number of tasks is plural, the electronic device 100 may alternately display the tasks at a specified interval. According to various embodiments, if a specified gesture input occurs on the dialog list (e.g., a speech bubble) of a specific user, the electronic device 100 may assign speech bubble content to the to-do or schedule of a first user.

According to various embodiments, a job information processing method according to an embodiment may include displaying a chat room, in which a plurality of users participate, in at least part of the display and displaying a window associated with job information of the selected at least one user so as to be overlapped with at least part of the chat room, in response to the selection of identification information associated with one user of the plurality of users.

According to various embodiments, a job information processing method may include displaying a chat room, in which a plurality of users participate, in at least part of a display, displaying identification information associated with at least one user selected among the plurality of users, in at least part of the chat room, and displaying a window associated with job information of the selected at least one user so as to be overlapped with the at least part of the chat room, in response to a user input to select the identification information.

According to various embodiments, the job information may include at least one of schedule information, to-do information, or file information.

According to various embodiments, the method may include generating new job information of the selected user depending on a specified input event and registering the new job information as new job information of the selected user.

According to various embodiments, the method may further include activating or deactivating the new job information generating area depending on the rating or settings of the user.

According to various embodiments, the method may further include registering job information of the selected user as group job information of all users participating in the chat room depending on the specified input event.

According to various embodiments, the method may further include outputting job information of the selected user in the chat room depending on the specified input event.

According to various embodiments, the method may further include including and outputting a list or job information selected among a dialog list displayed in the chat room or job information of the user, in an interest information list.

According to various embodiments, the method may further include registering job information selected among the job information of the selected user, in any specified other user depending on the specified input event.

According to various embodiments, the registering may include processing registration of the job information if a chat room operating condition of the user satisfies a specified condition.

According to various embodiments, the processing may include processing the registration of the job information if a chat room operating time for each user is within a specified time range, and outputting a guide message associated with impossibility of job registration processing if the chat room operating time for each user is out of the specified time range.

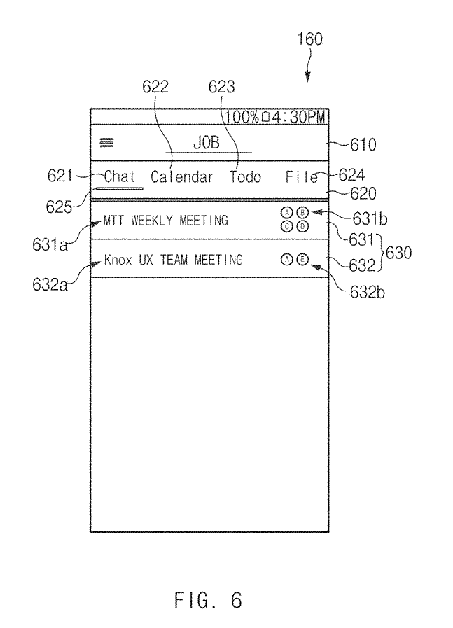

FIG. 6 illustrates an example of a basic screen interface associated with job information processing, according to an embodiment.

Referring to FIG. 6, the electronic device 100 may output a basic screen in the display 160 in association with the execution of a chat function or a messenger function. For example, the basic screen may include a title area 610, a job information area 624, and a chat room list area 630.

Text information indicating a screen provided depending on messenger function execution may be included in the title area 610. According to various embodiments, a setting item associated with a messenger function, or the like may be arranged in the title area 610. The title area 610 may be changed by an application designer or a user.

The job information area 624 may include a chat information item 621, a calendar information item 622, a to-do information item 623, and a file information item 624. The chat information item 621 may be an item for activating a chat window screen. The calendar information item 622 may be an item set to output calendar information associated with job information. The to-do information item 623 may be an item set to output pieces of to-do information associated with all chat rooms. The file information item 624 may be an item set to output file lists that are transmitted or received in all chat rooms. Alternatively, the file information item 624 may be an item set to output a list of pieces of specified file information.

For example, at least one chat room items generated in response to a user input or the request of other user(s) may be displayed in the chat room list area 630. According to various embodiments, in the case where there is no chat room item, the chat room list area 630 may be displayed as being empty. FIG. 6 illustrates an example in which there are two chat room items 631 and 632. For example, the chat room item 631 may include chat room title information 631a, and chat room participant information 631b. The chat room title information 631a may be set in response to a user input, may be set to identification information of a user generating a chat room, or may be set to information associated with to-do information registered in a chat room. The chat room participant information 631b may include the number of participants participating in the chat room item 631 and identification information (e.g., photo information, text information, or the like) capable of identifying the participants. For example, the chat room item 632 may include chat room title information 632a and chat room participant information 632b. For example, the chat room title information 632a may be set in association with to-do information set in a chat room. The chat room participant information 632b may be information corresponding to participants participating in the chat room item 632.

According to various embodiments, each of the chat room participant information 631b or the chat room participant information 632b may have a color different from the color of other participant information, depending on the amount of to-do information (e.g., time) (or the number), an arrival time of the due date of to-do information, or the like. As such, a user may intuitively determine whether any participant has information about urgent to-do or whether any participant has more or less to-do information.

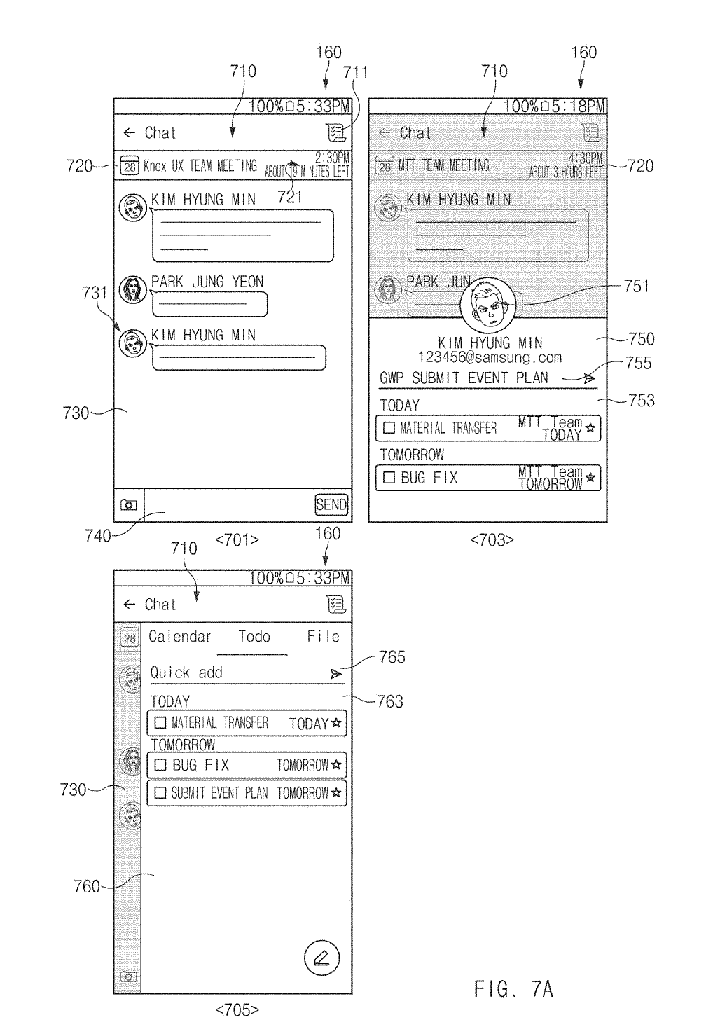

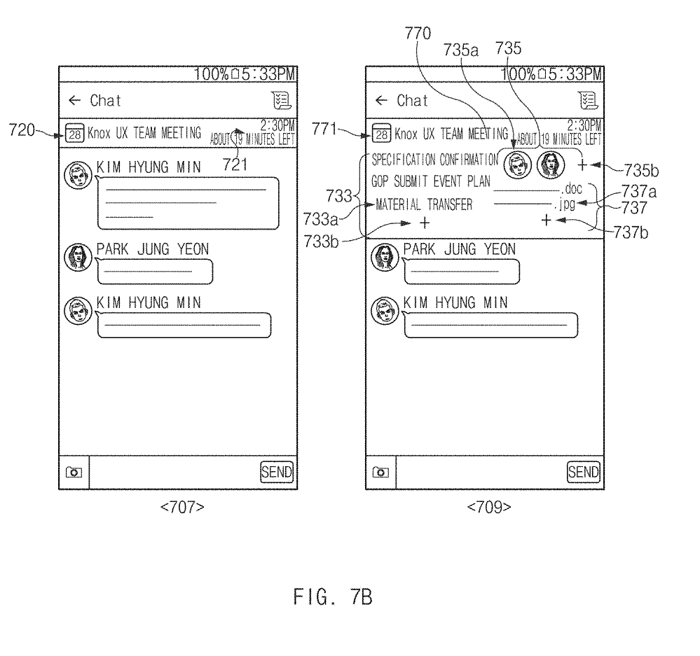

FIG. 7A is a view illustrating an example of a screen interface associated with job generation and job view, according to an embodiment.

Referring to FIG. 7A, as illustrated in state 701, the electronic device 100 may output a chat room in the display 160. For example, the chat room may include a title area 710, a chat room-related information display area 720, a dialog area 730, and an input window 740.

For example, the title area 710 may include a text or an image indicating a chat information item. In addition, the title area 710 may include a job object 711 set to display at least one of pieces of job information (e.g., calendar information, to-do information, file information, and the like).

For example, in the case where a plurality of chat rooms are present, the chat room-related information display area 720 may output information (e.g., title information of another chat room, or the like) about another chat room. According to various embodiments, the chat room-related information display area 720 may include due date information 721 of to-do information associated with another chat room. According to various embodiments, the chat room-related information display area 720 may output information about chat rooms, which are associated with to-do information within a specified time range, from among chat rooms. For example, the chat room-related information display area 720 may display information of chat rooms associated with schedules of the specified number among the most recent schedules (e.g., based on time to complete or time to finish, schedules, which are close to the corresponding time, of the specific number or schedules, which are most recently generated based on the schedule generation start time, of the specific number). According to various embodiments, the electronic device 100 may output other adjacent chat room lists of the specific number in the chat room-related information display area 720, depending on a location in a list of chat rooms being currently output. The chat room-related information display area 720 may sequentially display information about chat rooms.

For example, pieces of user identification information and dialog lists may be displayed in the dialog area 730. The pieces of user identification information may be pieces of information for distinguishing participants participating in the corresponding chat room. For example, the user identification information may be a user name, a nickname, a telephone number, or the like.

The input window 740 may output a text in response to a user input. Alternatively, the input window 740 may output an image, an emoticon, or the like in response to a user input. Pieces of information output to the input window 740 may be output to a chat room depending on a transmission request. In this operation, pieces of information entered in the input window 740 may be transmitted to an external electronic device.

According to various embodiments, if a specified input event (e.g., a tap event, a double tap event, a long press, sweep, a pressure event, or the like) occurs in the dialog area 730 in association with a specific user identification information 731, as illustrated in state 703, the electronic device 100 may output a secondary window 750 (or a job window). The electronic device 100 may adjust a display method (e.g., blur, resolution, brightness, or the like) of an area other than the secondary window 750, depending on the output of the secondary window 750.

For example, the secondary window 750 may include user identification information 751, a to-do information list 753 of the selected user, and a to-do information generation area 755. If information input is generated in the to-do information generation area 755, the electronic device 100 may generate new to-do information and may allow the generated to-do information to be registered as to-do information of the corresponding user. According to an embodiment, if the to-do information generation area 755 is selected, the electronic device 100 may output a virtual input panel (e.g., a QWERTY keypad or the like). In this operation, the electronic device 100 may secure a space in which the virtual input panel is capable of being displayed, by moving the location of the secondary window 750. If a user enters information through the virtual input panel, the entered information may be output to the to-do information generation area 755. If an input event corresponding to to-do information transmission occurs in the to-do information generation area 755, the electronic device 100 may transmit new to-do information to an electronic device of the corresponding user. Furthermore, the electronic device 100 may register the new to-do information in a chat room.

According to various embodiments, the to-do information generation area 755 may be omitted depending on user information. For example, participants participating in a chat room may have a rating according to settings. At this time, when identification information of a user of a different rating (e.g., relatively high rating) is selected in an electronic device of a user of a specific rating (e.g., relatively low rating), the secondary window 750 may display the to-do information generation area 755 to be deactivated or to be omitted. According to various embodiments, when user identification information is selected in an electronic device of user of a specified rating, the secondary window 750 may display the to-do information generation area 755 to be in an active state. The rating may be adjusted by a chat room creator or the highest rating user of the chat room.

According to various embodiments, the secondary window 750 may support the deletion of to-do information item included in to-do information list of a user or to-do information list of other user(s). In this case, if a to-do information deletion request occurs, the electronic device 100 may transmit a message for requesting the allowance of other user(s) (e.g., a chat room creator or the highest rating user) associated with to-do information, to an electronic device of the other user(s). If the to-do information deletion permission occurs in the electronic device of the other user(s), the corresponding to-do information may be deleted.

According to various embodiments, as illustrated in state 705, the electronic device 100 may output a group to-do information window 760. According to an embodiment, when a specified input event occurs, the electronic device 100 may output the group to-do information window 760 that covers at least part of a chat room screen. For example, the group to-do information window 760 may include a group to-do information area 763 outputting pieces of group to-do information (e.g., pieces of to-do information that each of participants has) registered in a chat room and a group to-do information generation item 765.

The group to-do information generation item 765 may be configured to generate new group to-do information registered in all the participants participating in the chat room. The group to-do information generation item 765 may be provided to only the chat room screen of a chat room creator or the highest rating user or a user of a specified rating. If being generated through the group to-do information generation item 765, the new group to-do information may be registered as new group to-do information of all the participants participating in the chat room. The electronic device generating the new group to-do information may transmit the new group to-do information to electronic devices of participants participating in the chat room. The new group to-do information may be transmitted to other participant electronic devices in a push form. Alternatively, the electronic device 100 may transmit the new group to-do information to the other electronic devices and may receive a response to the new group to-do information.

FIG. 7B is a view illustrating an example of a screen interface associated with view of chat room detail information, according to an embodiment.

Referring to FIG. 7B, as illustrated in state 707, the electronic device 100 may output a chat room to the display 160. For example, the chat room may include a chat room-related information display area 720. The chat room-related information display area 720 may include due date information 721 of to-do information associated with another chat room.

According to various embodiments, as illustrated in state 709, the electronic device 100 may output a chat room detail information area 770 in response to the occurrence of a specified input event, for example, an event to select the chat room-related information display area 720.

For example, the chat room detail information area 770 may include a meeting title area 771, a meeting agenda area 733, a meeting participant area 735, and a meeting-related file area 737.

The meeting agenda area 733 may include meeting agenda information 733a and a meeting agenda information generation item 733b. The meeting agenda information 733a may include agenda information of meetings, which are being displayed in a chat room-related information display area. The meeting agenda information generation item 733b may be an item for registering new meeting agenda information in association with the corresponding chat room. If the meeting agenda information generation item 733b is selected, the electronic device 100 may output an input window for generating meeting agenda information of the related chat room.

The meeting participant area 735 may include meeting participant information 735a and a meeting participant information generation item 735b. The meeting participant information 735a may include meeting participant information of each of chat rooms included in the chat room-related information display area, for each chat room. Alternatively, the meeting participant information 735a may include meeting participant information associated with the selected specific chat room list (e.g., a list selected by a touch event in a state where a specific chat room list is output in the chat room-related information display area). The meeting participant information generation item 735b may be an item for adding a new meeting participant or deleting a previous meeting participant. If the meeting participant information generation item 735b is selected, the electronic device 100 may display a phonebook, or the like to transmit a message for requesting a new participant to participate in the corresponding meeting.

The meeting-related file area 737 may include meeting-related file information 737a and a meeting-related file information generation item 737b. The meeting-related file information 737a may include a list of the registered files in the corresponding chat room. If the meeting-related file information generation item 737b is selected, the electronic device 100 may output a registration window for uploading a new file.

According to various embodiments, if a specified event (e.g., a click event) to select the meeting agenda information generation item 733b occurs, the electronic device 100 may output a secondary window for generating meeting agenda information.

According to various embodiments, if a specified event (e.g., a click event) to select the meeting participant information 735a occurs, the electronic device 100 may output a secondary window for entering information such as information about meeting attendance (e.g., whether to attend a meeting or a meeting attendance time) or the like. According to various embodiments, if a specified event (e.g., a click event) to select the meeting participant information generation item 735b occurs, the electronic device 100 may output a secondary window for generating meeting participant information. According to various embodiments, if a specified event (e.g., click event) to select the meeting-related file information generation item 737b occurs, the electronic device 100 may output a secondary window for generating file information about the meeting, in the display 160.

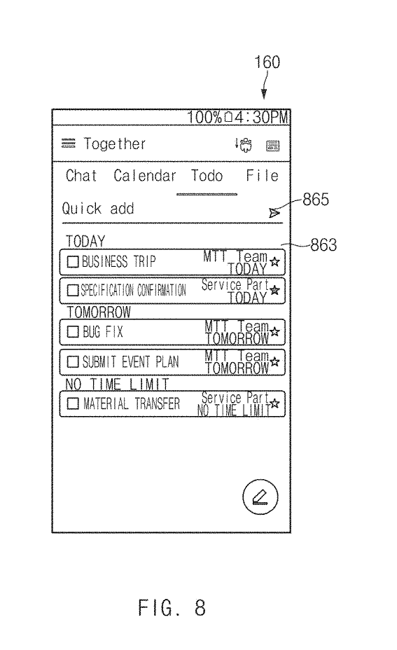

FIG. 8 is a view illustrating an example of a screen interface associated with view of job information about all chat rooms, according to an embodiment.

Referring to FIG. 8, the electronic device 100 may output a to-do information screen associated with all chat rooms in the display 160 in response to the occurrence of a specified input event. In this regard, the electronic device 100 may collect pieces of to-do information registered in chat rooms. The electronic device 100 may output the collected pieces of to-do information in the form of a list. For example, the to-do information screen associated with all chat rooms may include an entire to-do information generation area 863 and an entire to-do information display area 865.

According to various embodiments, the electronic device 100 may distinguish and output the pieces of to-do information for each date in the entire to-do information display area 865. In this regard, the electronic device 100 may verify due date information of the pieces of to-do information or may verify generation time information of the pieces of to-do information. The electronic device 100 may sort and display the pieces of to-do information in order of due date information depending on settings. Alternatively, the electronic device 100 may sort and display the pieces of to-do information in order of generation time information depending on settings.

According to various embodiments, the electronic device 100 may output information, which does not have a due date setting, in the display 160 so as to be distinguished. Furthermore, the electronic device 100 may output urgent to-do information so as to be distinguished from other pieces of to-do information. According to an embodiment, in the case where the deadline of to-do information is approaching within a specified time, the electronic device 100 may highlight and display the deadline of the to-do information. Alternatively, the electronic device 100 may output audio information in association with the urgent to-do information. According to various embodiments, if specific to-do information is selected, the electronic device 100 may output chat room information associated with the selected to-do information or pieces of user identification information associated with the selected to-do information.

According to various embodiments, the entire to-do information generation area 863 may be configured to generate the entire to-do information shared with participants of all chat rooms. If to-do information is generated through the entire to-do information generation area 863, the electronic device 100 may transmit the new entire to-do information to electronic devices of participants participating in all chat rooms. Furthermore, the electronic device 100 may newly register the generated new entire to-do information in the corresponding screen.

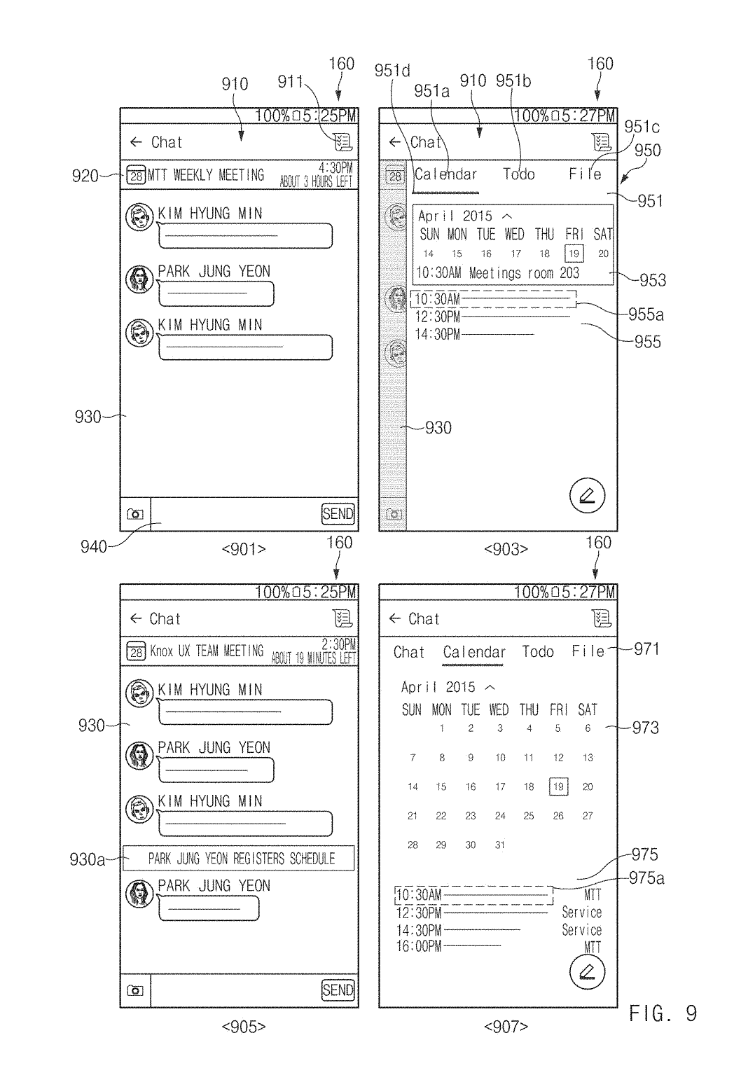

FIG. 9 is a view illustrating an example of a screen interface associated with calendar information generation, according to an embodiment.

Referring to FIG. 9, as illustrated in state 901, the electronic device 100 may output a chat room screen in the display 160. For example, the chat room screen may include a title area 910, a chat room-related information display area 920, a dialog area 930, and an input window 940. According to various embodiments, if a specified input event (e.g., an event to select a job object 911 disposed in the title area 910, a drag input to move from right to left, or the like) occurs, as illustrated in state 903, the electronic device 100 may output a calendar window 950.

For example, the calendar window 950 may include a job item area 951, a calendar information area 953, and a schedule list area 955. The job item area 951 may include a calendar item 951a, a to-do item 951b, and a file item 951c. Depending on the display state of the calendar window 950, an indicator bar 951d may be displayed (e.g., displayed in the lower portion of the calendar item 951a) in association with the calendar item 951a. For example, the calendar information area 953 may include pieces of date information on a daily, weekly, or monthly basis. In FIG. 9, the calendar information area 953 may be displayed on a weekly basis. If a specific date is indicated in the calendar information area 953 or if today's date is selected, the electronic device 100 may output schedule information associated with the corresponding date in the schedule list area 955. For example, the schedule list area 955 may include a schedule information generation item.

If new schedule information 955a is registered in the schedule list area 955 through the schedule information generation item, as illustrated in state 905, the new schedule information 955a may be registered in all participants participating in a chat room or a specified participant. A message 930a associated with the registration of new schedule information may be output in the dialog area 930.

According to various embodiments, if a calendar information item (e.g., a view item of calendar information about all chat rooms) is selected in a basic screen, as illustrated in state 907, the entire calendar screen may be output to the display 160. For example, the entire calendar screen may include a job information area 971, a basic calendar information area 973, and an entire schedule list area 975. Information of a set date unit (e.g., a month unit) may be output in the basic calendar information area 973. If a specific date is selected from the basic calendar information area 973, schedule information of all chat rooms corresponding to the selected date may be output in the entire schedule list area 975. According to various embodiments, if the new schedule information 955a is registered in a specific chat room through state 903 and state 905, the entire schedule list area 975, to which new entire schedule information 975a is added, may be displayed in the entire calendar screen.

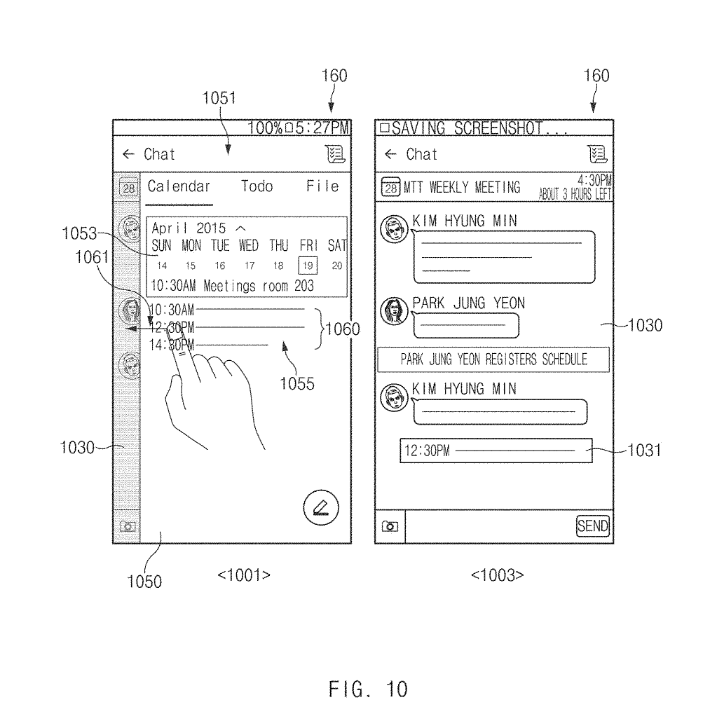

FIG. 10 is a view illustrating an example of a screen interface associated with sharing of calendar information, according to an embodiment.

Referring to FIG. 10, as illustrated in state 1001, the electronic device 100 may output a calendar window 1050 in the display 160 so as to cover at least part of a dialog area 1030. For example, the calendar window 1050 may include a job item area 1051, a calendar information area 1053, and a schedule list area 1055. At least one or more memo items 1060 may be arranged in the schedule list area 1055.

If an input event (e.g., an input event to move to the dialog area 1030 after the selection of a specific memo item 1061, a pressure event associated with the specific memo item 1061, or the like) associated with the specific memo item 1061 occurs, as illustrated in state 1003, the electronic device 100 may output a guide message 1031 associated with the specific memo item 1061 in the dialog area 1030. According to an embodiment, the electronic device 100 may register schedule information associated with the specific memo item 1061 as group schedule information of participants participating in a chat room. In this regard, the electronic device 100 may transmit the schedule information associated with the specific memo item 1061 to an electronic device of a participant. According to an embodiment, the electronic device 100 may provide information associated with the guide message 1031 in response to a user input associated with the guide message 1031. For example, the electronic device 100 may provide the calendar window 1050 or a schedule application in response to a user input to select the guide message 1031.

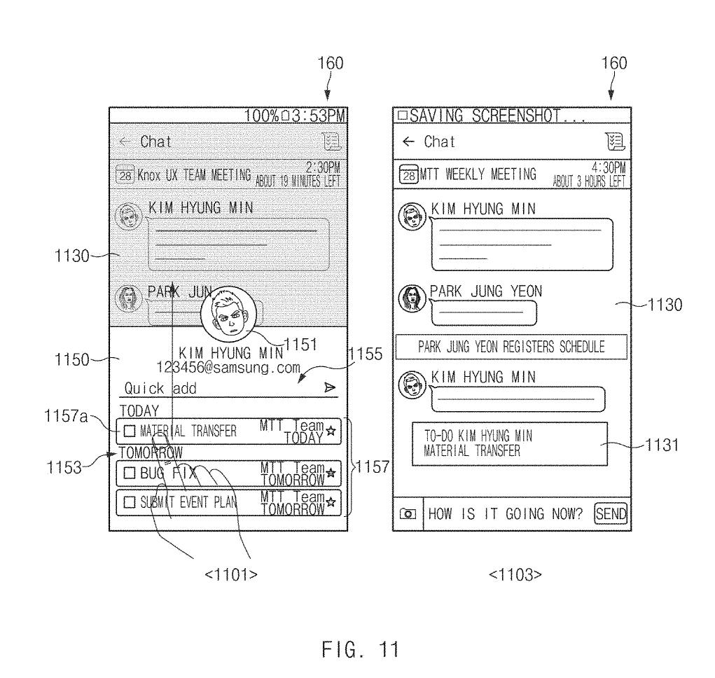

FIG. 11 is a view illustrating an example of a screen interface associated with sharing of to-do information, according to an embodiment.

Referring to FIG. 11, as illustrated in state 1101, the electronic device 100 may output a secondary window 1150, which covers at least part of a dialog area 1130, in the display 160. For example, the secondary window 1150 may include user identification information 1151, to-do information list 1153 of the selected user, and a to-do information generation area 1155. According to various embodiments, the electronic device 100 may receive an input event (e.g., an input event to select a to-do information item 1157a, an input event to drag the to-do information item 1157a in the direction of the dialog area 1130, a pressure input associated with the to-do information item 1157a, or the like) associated with at least one to-do information item 1157 displayed in the to-do information list 1153.

If the above-described input event occurs, as illustrated in state 1103, the electronic device 100 may output a guide message 1131 corresponding to the selected to-do information item 1157a in the dialog area 1130 in response to the corresponding input event. According to an embodiment, for example, the selected to-do information item 1157a may be registered as to-do information of all the participants in a chat room. According to an embodiment, the electronic device 100 may provide information associated with the guide message 1131 in response to a user input associated with the guide message 1131. For example, the electronic device 100 may provide the secondary window 1150 or a to-do application in response to a user input to select the guide message 1131.

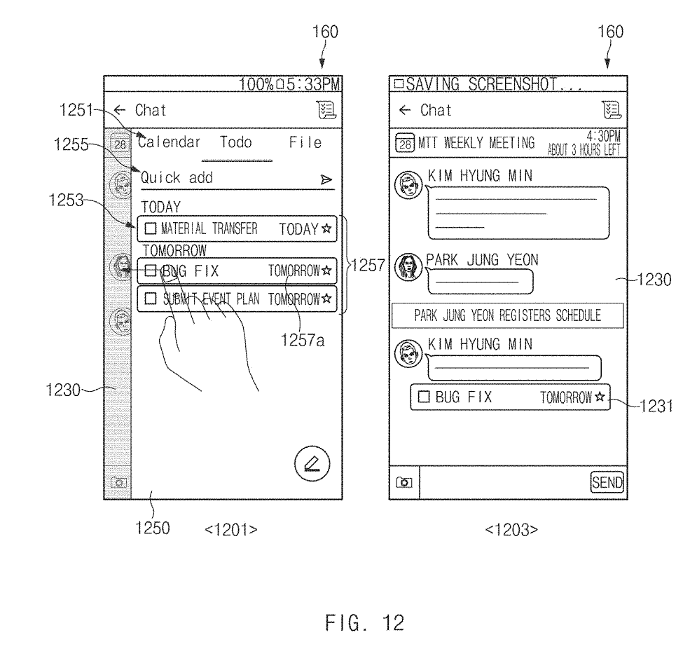

FIG. 12 is a view illustrating another example of a screen interface associated with sharing of to-do information, according to an embodiment.

Referring to FIG. 12, as illustrated in state 1201, the electronic device 100 may output a to-do window 1250, which covers at least part of a dialog area 1230, in the display 160. For example, the to-do window 1250 may include a job item area 1251, a to-do information generation area 1255, and a to-do information list area 1253. According to various embodiments, the electronic device 100 may receive an input event (e.g., an input event to select a to-do information item 1257a or an input event to drag the to-do information item 1257a in the direction of the dialog area 1230) associated with at least one to-do information item 1257 displayed in the to-do information list area 1253.

According to an embodiment, the to-do window 1250 may further include a user information area (not illustrated). For example, at least one or more pieces of information about a user participating in a chat room may be displayed in the user information area. If the information about a user displayed in the user information area is selected, the electronic device 100 may provide information corresponding to the selected user. Alternatively, if to-do is entered in a state where a user is selected, the electronic device 100 may assign the to-do to the selected user.

If the above-described input event occurs, as illustrated in state 1203, the electronic device 100 may output a guide message 1231 corresponding to the selected to-do information item 1257a in the dialog area 1230 in response to the corresponding input event. For example, the selected to-do information item 1257a may be registered as to-do information of all the participants in a chat room.

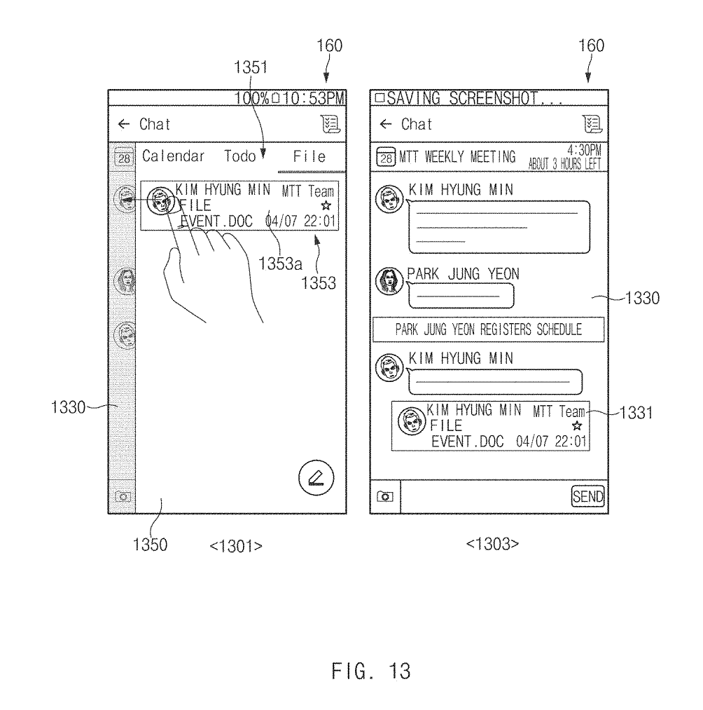

FIG. 13 is a view illustrating an example of a screen interface associated with sharing of file information, according to an embodiment.

Referring to FIG. 13, as illustrated in state 1301, the electronic device 100 may output a file window 1350, which covers at least part of a dialog area 1330, in the display 160. For example, the file window 1350 may include a job item area 1351 and a file information area 1353. According to various embodiments, the electronic device 100 may receive an input event (e.g., an input event to select a file item 1353a or an input event to drag the file item 1353a in the direction of the dialog area 1330) associated with at least one file information item 1353a displayed in the file information area 1353.

If the above-described input event occurs, as illustrated in state 1303, the electronic device 100 may output a guide message 1331 corresponding to the selected file item 1353a in the dialog area 1330 in response to the corresponding input event. According to an embodiment, the guide message 1331 may be in a form capable of downloading the file item 1353a. The electronic device 100 may transmit the guide message 1331 to an electronic device of another participant of the corresponding chat room. The electronic device of another participant may output the guide message 1331 in a dialog area. If an input event to select the guide message 1331 occurs, the electronic device of another participant may download and store file information corresponding to the corresponding file item 1353a.

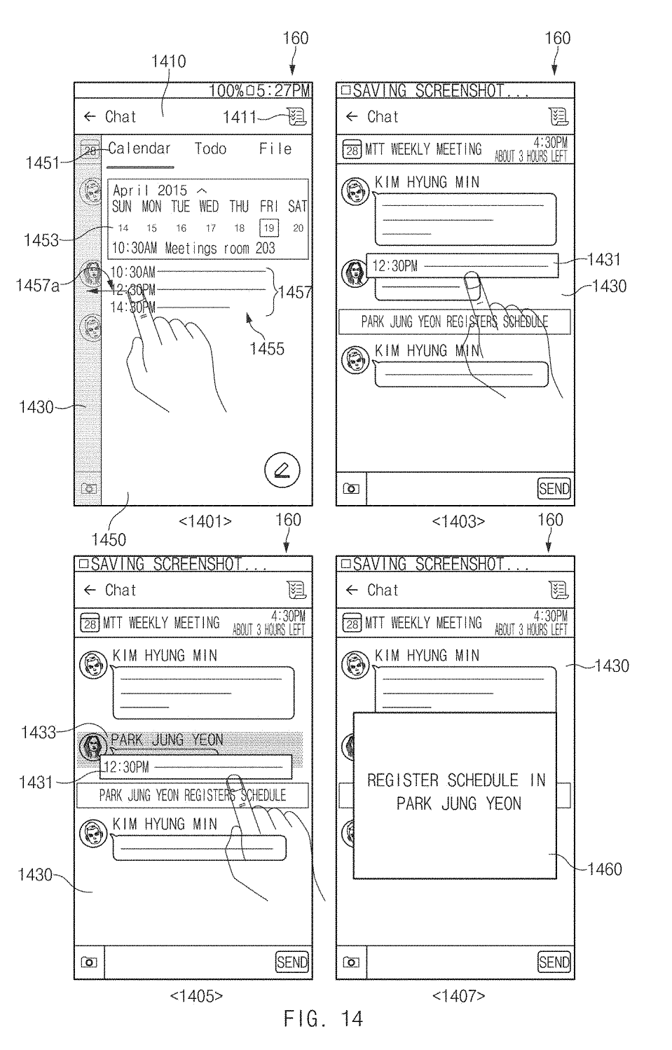

FIG. 14 is a view illustrating an example of a screen interface associated with calendar information direct transmission, according to an embodiment.

Referring to FIG. 14, the electronic device 100 may output a chat room including a dialog area 1430, in the display 160. If a specified input event, for example, an event to select a job object 1411 disposed in a title area 1410 occurs, as illustrated in state 1401, the electronic device 100 may output a calendar window 1450 in the display 160 in response to the occurrence of the selected event. Alternatively, if a calendar information item provided as a sub item is selected upon selecting the job object 1411, the electronic device 100 may output the calendar window 1450. Alternatively, the electronic device 100 may output the calendar window 1450 by default depending on the previous usage history (e.g., a recent usage history, the most used history, user settings, or the like) of the job object 1411. The calendar window 1450 may be arranged to cover at least part of the dialog area 1430. For example, the calendar window 1450 may include a job item area 1451, a calendar information area 1453, and a schedule list area 1455. The schedule list area 1455 may include at least one memo item 1457 (e.g., schedule information).

If an event (e.g., a drag event to move to the dialog area 1430 after the memo item 1457a is selected) associated with a specific memo item 1457a included in the schedule list area 1455 occurs, as illustrated in state 1403, the electronic device 100 may remove the calendar window 1450 in the display 160. Furthermore, the electronic device 100 may output a memo object 1431 corresponding to the memo item 1457a on the dialog area 1430. In this operation, the electronic device 100 may display the memo object 1431 at the current point of a drag event maintained as being a touchdown state.

As illustrated in state 1405, the memo object 1431 may move in response to an additional event (e.g., in the touchdown state, an event to drag the memo object 1431 in a specific direction) and may be displayed. In the case where the memo object 1431 is at least partly overlapped with a specific dialog list 1433, the display state of the corresponding dialog list 1433 may be changed.

According to various embodiments, if a specified event (e.g., a touch release event) occurs in a state where at least part of the memo object 1431 is overlapped with the specific dialog list 1433, the electronic device 100 may register schedule information corresponding to a memo object as the schedule of a participant corresponding to the dialog list 1433. In this operation, if the schedule information is registered as the schedule of a specific participant, as illustrated in state 1407, the electronic device 100 may output a guide message 1460 corresponding to schedule information registration. As described above, the electronic device 100 may provide a function to directly register the schedule information in the electronic device of the specific participant.

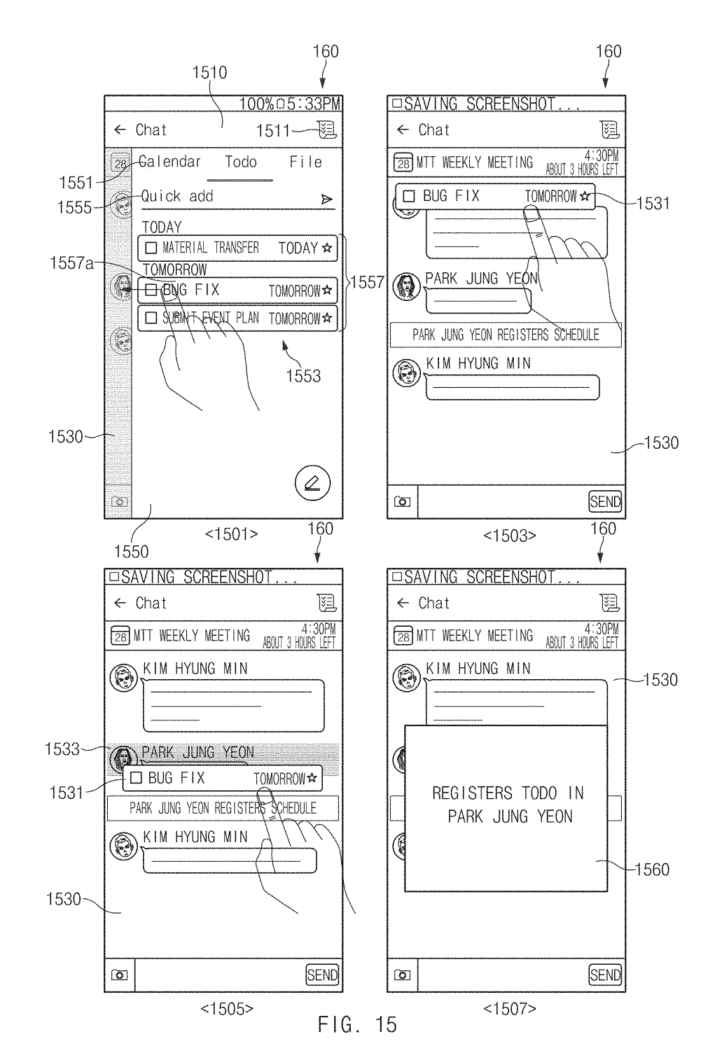

FIG. 15 is a view illustrating an example of a screen interface associated with to-do information direct transmission, according to an embodiment.

Referring to FIG. 15, the electronic device 100 may output a chat room including a dialog area 1530, in the display 160. As illustrated in state 1501, the electronic device 100 may output a to-do window 1550 in response to the occurrence of a specified input event, for example, an event to select a job object 1511 disposed in a title area 1510. Alternatively, if a to-do information item provided as a sub item is selected upon selecting the job object 1511, the electronic device 100 may output the to-do window 1550. Alternatively, the electronic device 100 may output the to-do window 1550 by default depending on the previous usage history (e.g., a recent usage history, the most used history, user settings, or the like) of the job object 1511. The to-do window 1550 may be arranged to cover at least part of the dialog area 1530. For example, the to-do window 1550 may include a job item area 1551, a to-do information generation area 1555, and a to-do information area 1553. The to-do information area 1553 may include at least one to-do information item 1557.

If an event (e.g., a drag event to move to the dialog area 1530 after the to-do information item 1557a is selected) associated with a specific to-do information item 1557a included in the to-do information area 1553 occurs, as illustrated in state 1503, the electronic device 100 may remove the to-do window 1550 in the display 160. Furthermore, the electronic device 100 may output a to-do information object 1531 corresponding to the to-do information item 1557a on the dialog area 1530. In this operation, the electronic device 100 may display the to-do information object 1531 at the current point of a drag event maintained as being a touchdown state. As illustrated in state 1505, the to-do information object 1531 may move in response to a specified event and may be displayed. In the case where the to-do information object 1531 is at least partly overlapped with a specific dialog list 1533, the display state of the corresponding dialog list 1533 may be changed.

According to various embodiments, if a specified event (e.g., a touch release event) occurs in a state where at least part of the to-do information object 1531 is overlapped with the specific dialog list 1533, the electronic device 100 may register to-do information corresponding to a to-do information object as the new to-do information of a participant corresponding to the dialog list 1533. In this operation, if the selected to-do information is registered as the new to-do information of a specific participant, as illustrated in state 1507, the electronic device 100 may output a guide message 1560 corresponding to the new to-do information registration. As described above, the electronic device 100 may provide a function (e.g., to transmit to-do information to the electronic device of a specific participant and to store the to-do information in the electronic device of the specific participant) to directly register to-do information in the electronic device of a specific participant.

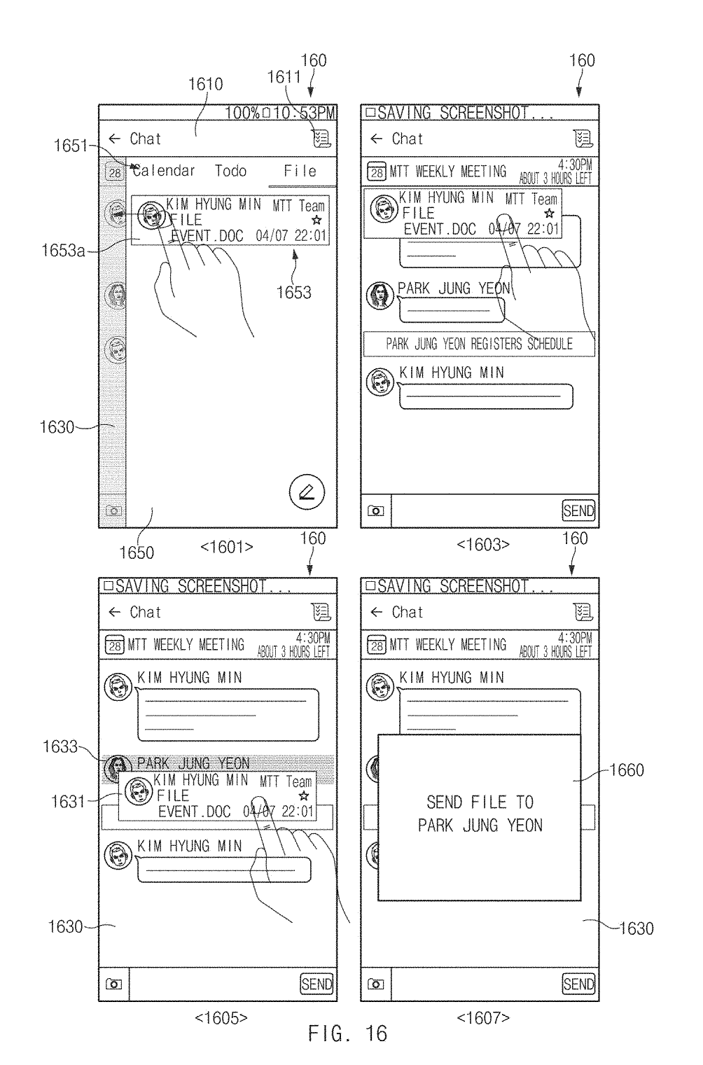

FIG. 16 is a view illustrating an example of a screen interface associated with file information direct transmission, according to an embodiment.

Referring to FIG. 16, the electronic device 100 may output a chat room including a dialog area 1630, in the display 160. As illustrated in state 1601, the electronic device 100 may output a file window 1650 in response to the occurrence of a specified input event, for example, an event to select a job object 1611 disposed in a title area 1610. For example, the file window 1650 may be arranged to cover at least part of the dialog area 1630. For example, the file window 1650 may include a job item area 1651 and a file information area 1653.

If an event (e.g., a drag event to move to the dialog area 1630 after the file item 1653a is selected) associated with a specific file item 1653a included in the file information area 1653 occurs, as illustrated in state 1603, the electronic device 100 may remove the file window 1650 in the display 160. Furthermore, the electronic device 100 may output a file object 1631 corresponding to the file item 1653a on the dialog area 1630. In this operation, the electronic device 100 may display the file object 1631 at the current point of a drag event maintained as being a touchdown state.

As illustrated in state 1605, the file object 1631 may move in response to an additional drag event (e.g., an event to drag the file object 1631 in the touchdown state in a specific direction) and may be displayed. In the case where the file object 1631 is at least partly overlapped with a specific dialog list 1633, the display state of the corresponding dialog list 1633 may be changed.

According to various embodiments, if a specified event (e.g., a touch release event) occurs in a state where at least part of the file object 1631 is overlapped with the specific dialog list 1633, the electronic device 100 may transmit file information corresponding to a file object to the electronic device of a participant corresponding to the dialog list 1633. In this regard, as illustrated in state 1607, the electronic device 100 may output a guide message 1660 corresponding to file information transmission. As described above, the electronic device 100 may provide a function to directly transmit the file information to the electronic device of the specific participant.

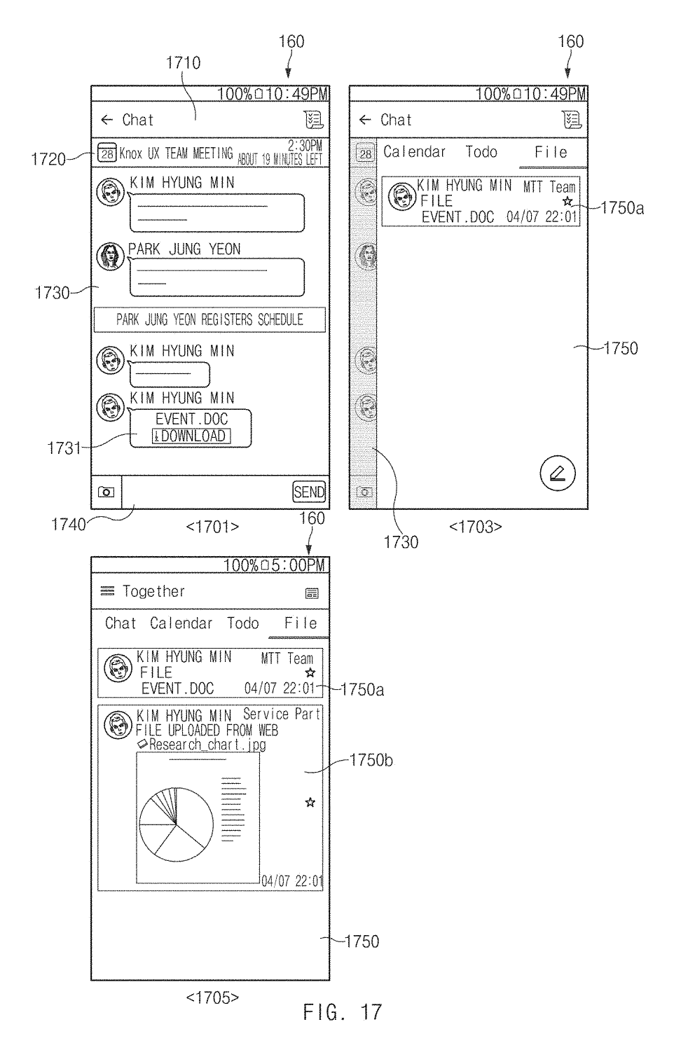

FIG. 17 is a view illustrating an example of a screen interface associated with file view, according to an embodiment.

Referring to FIG. 17, as illustrated in state 1701, the electronic device 100 may output a chat room screen in the display 160. For example, a chat room screen may include a title area 1710, a chat room-related information display area 1720, a dialog area 1730, and an input window 1740. A file object 1731 may be output to the dialog area 1730 in association with file item registration.

If a specified event to select the file object 1731 occurs, as illustrated in state 1703, the electronic device 100 may output a file window 1750. If the download of file information corresponding to the selected file object 1731 is completed, the file window 1750 may display a file item 1750a corresponding to the selected file object 1731.

Alternatively, the file window 1750 may display an indicator corresponding to a state where the file object 1731 is being received, during the download of the file information.

According to various embodiments, if a file information item is selected in a basic screen, as illustrated in state 1705, the electronic device 100 may output a file information list that is downloaded through all chat rooms. Alternatively, the electronic device 100 may output the file information list that is transmitted or received in all chat rooms. For example, the electronic device 100 may output a plurality of file items 1750a and 1750b in the file window 1750. The electronic device 100 may arrange file information, which has been recently received, in the upper portion (an upper end) or lower portion (a lower end) of the screen.

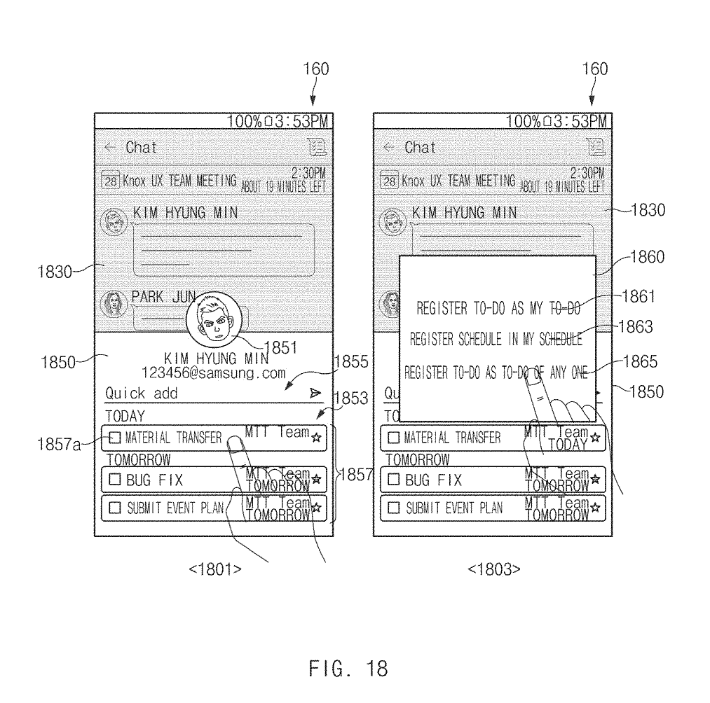

FIG. 18 is a view illustrating an example of a screen interface associated with information linkage processing, according to an embodiment.

Referring to FIG. 18, as illustrated in state 1801, the electronic device 100 may output a secondary window 1850, which covers at least part of a dialog area 1830. For example, the secondary window 1850 may include user identification information 1851, to-do information list 1853 of the selected user, and a to-do information generation area 1855. According to various embodiments, the electronic device 100 may receive an input event (e.g., a long press event to select a to-do information item 1857a) associated with at least one to-do information item 1857 displayed in the to-do information list 1853.

If the above-described input event occurs, as illustrated in state 1803, the electronic device 100 may output a to-do function window 1860 in response to the corresponding an input event. For example, the to-do function window 1860 may include an item 1861 registered as to-do information of a user, an item 1863 registered in the schedule of the user, and an item 1865 registered as to-do information of any one. If the item 1861 registered as to-do information of the user is selected, the electronic device 100 may register to-do information corresponding to the selected to-do information item 1857a as new to-do information of the user. In the case where the item 1863 registered in the schedule of the user is selected, the electronic device 100 may register the schedule corresponding to the to-do information as the schedule information of the user. If the item 1865 registered as to-do information of any one is selected, the electronic device 100 may output user identification information of another participant participating in a chat room or user identification information of participants participating in all chat rooms. The electronic device 100 may register to-do information based on the selected user identification information. According to various embodiments, if a check box is selected in the secondary window 1850, to-do registration associated with the check box may be completed. Alternatively, if one of list items displayed in the to-do function window 1860 is selected, the electronic device 100 may output the detailed screen associated with the selected item in the display 160.

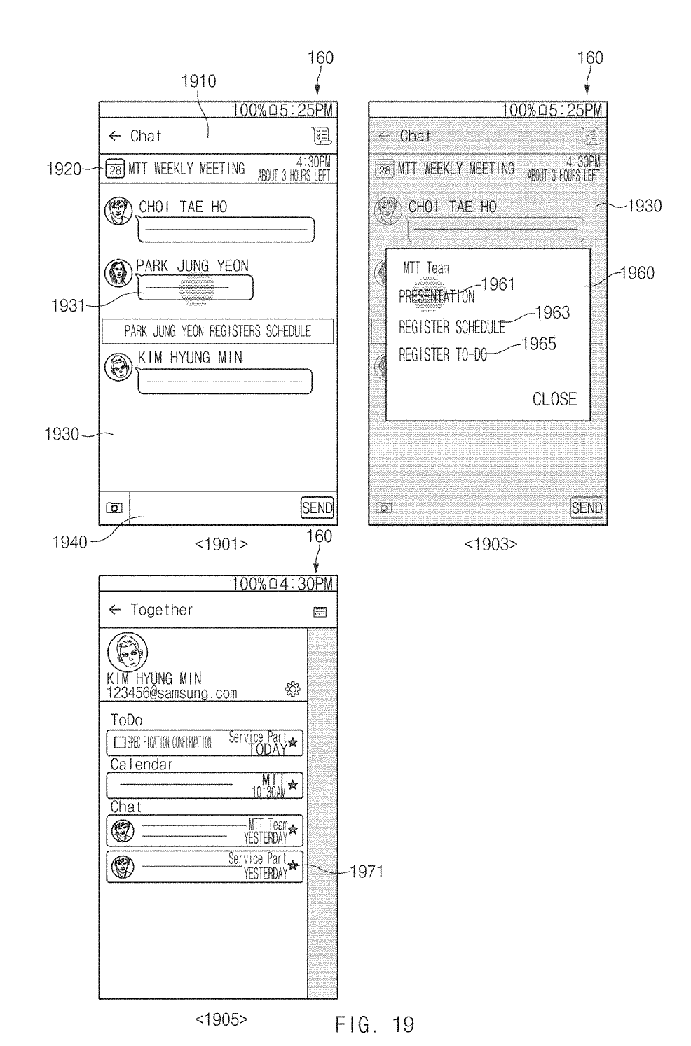

FIG. 19 is a view illustrating an example of a screen interface associated with interest information processing, according to an embodiment.

Referring to FIG. 19, as illustrated in state 1901, the electronic device 100 may output a chat room screen in the display 160. For example, a chat room screen may include a title area 1910, a chat room-related information display area 1920, a dialog area 1930, and an input window 1940. Dialog lists including pieces of user identification information may be displayed in the dialog area 1930.

If a specified event (e.g., a touch event to long-press an area in which a dialog list 1931 is displayed, or the like) to select a specific dialog list 1931 occurs, as illustrated in state 1903, the electronic device 100 may output a function window 1960. For example, the function window 1960 may include an interest information processing item 1961, a schedule registration item 1963, a to-do registration item 1965, or the like.

If the interest information processing item 1961 is selected, as illustrated in state 1905, the electronic device 100 may process the selected dialog list 1931 as a new interest information item 1971. According to an embodiment, the electronic device 100 may output a list associated with pieces of interest information. The new interest information item 1971 may be arranged in the lower portion or the upper portion of the corresponding list. According to various embodiments, the electronic device 100 may output a list screen associated with pieces of interest information as a separate window. According to an embodiment, if the to-do registration item 1965 is selected, the electronic device 100 may output a user interface associated with to-do registration described in FIG. 11. If the schedule registration item 1963 is selected, the electronic device 100 may output a user interface for registering a schedule, such as a calendar window.

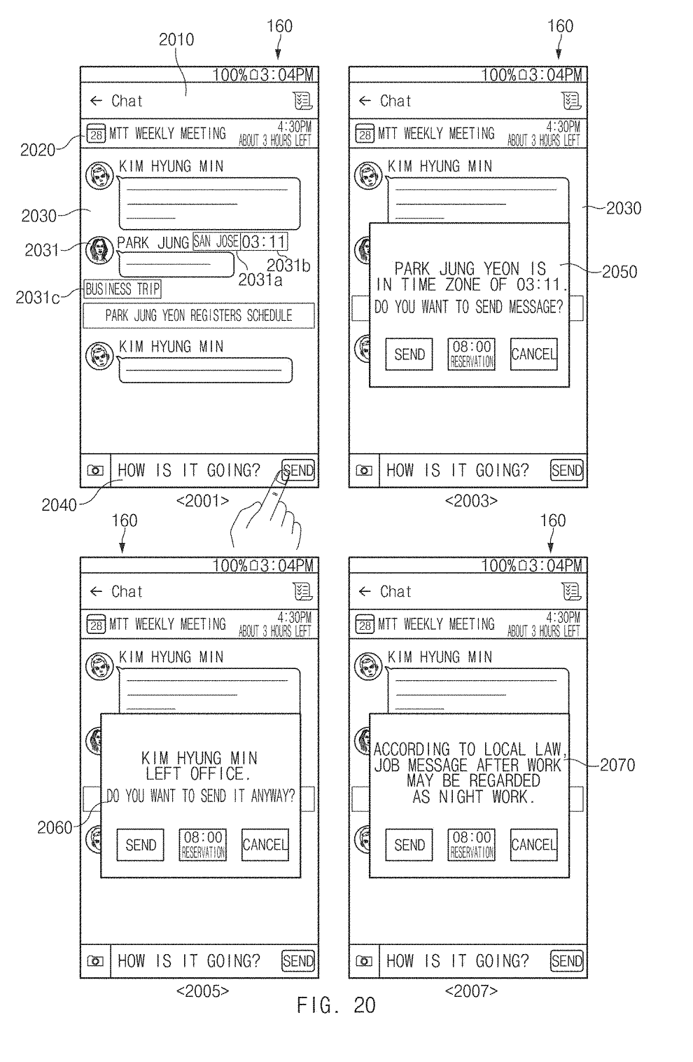

FIG. 20 is a view illustrating an example of a screen interface associated with job information processing according to user context, according to an embodiment.

Referring to FIG. 20, as illustrated in state 2001, the electronic device 100 may output a chat room screen in the display 160. For example, a chat room screen may include a title area 2010, a chat room-related information display area 2020, a dialog area 2030, and an input window 2040. Dialog lists including pieces of user identification information may be displayed in the dialog area 2030. In the dialog area 2030, the electronic device 100 may output information according to user context. For example, the electronic device 100 may collect context information (e.g., location information, time information, punctuality information, or the like) associated with specific user identification information 2031. The electronic device 100 may display the collected context information at a location adjacent to a location at which the user identification information 2031 is displayed. For example, the electronic device 100 may output location information 2031a, local time information 2031b at a point at which an electronic device associated with the user identification information 2031 is located, or punctuality information 2031c (e.g., information corresponding to a closing state, a business trip state, or the like) set by the corresponding participant.

The input window 2040 may output a text or an image corresponding to a user input. After a text or image input is completed, information entered in response to a user input may be transmitted to electronic devices of other participants associated with a chat room. In this operation, the electronic device 100 may output various guide messages associated with information transmission, depending on the context of other electronic devices. According to an embodiment, as illustrated in state 2003, the electronic device 100 may output a first guide message 2050 overlapped with at least part of the dialog area 2030. For example, the first guide message 2050 may be output depending on the time information of an electronic device of a participant receiving information. For example, in the case where the local time of the electronic device of the participant is within sleeping hours (e.g., 10:00˜07:00), the first guide message 2050 may be output. According to various embodiments, the electronic device 100 may output a second guide message 2060 overlapped with at least part of the dialog area 2030. For example, in the case where the local time of the electronic device of the participant receiving information is out of office hours (e.g., 09:00˜18:00), the second guide message 2060 may be output. As in that described above, the electronic device 100 may output a third guide message 2070. In the case where information associated with a job is transmitted out of office hours, the third guide message 2070 may include contract information according to local laws. In this regard, the electronic device 100 may store the local laws in advance or may obtain the local laws from a specified server device.

The electronic device 100 may obtain the local time information of the participant electronic device in association with the output of the above-described guide messages. For example, the electronic device 100 may obtain the current location information of the participant electronic device and may calculate local time information based on the current location information. For example, the participant electronic device may provide the current location information. In association with the output of the third guide message 2070, the electronic device 100 may store the contract information in a memory, may collect the contract information from a server or the like, and may verify the contract condition with time.

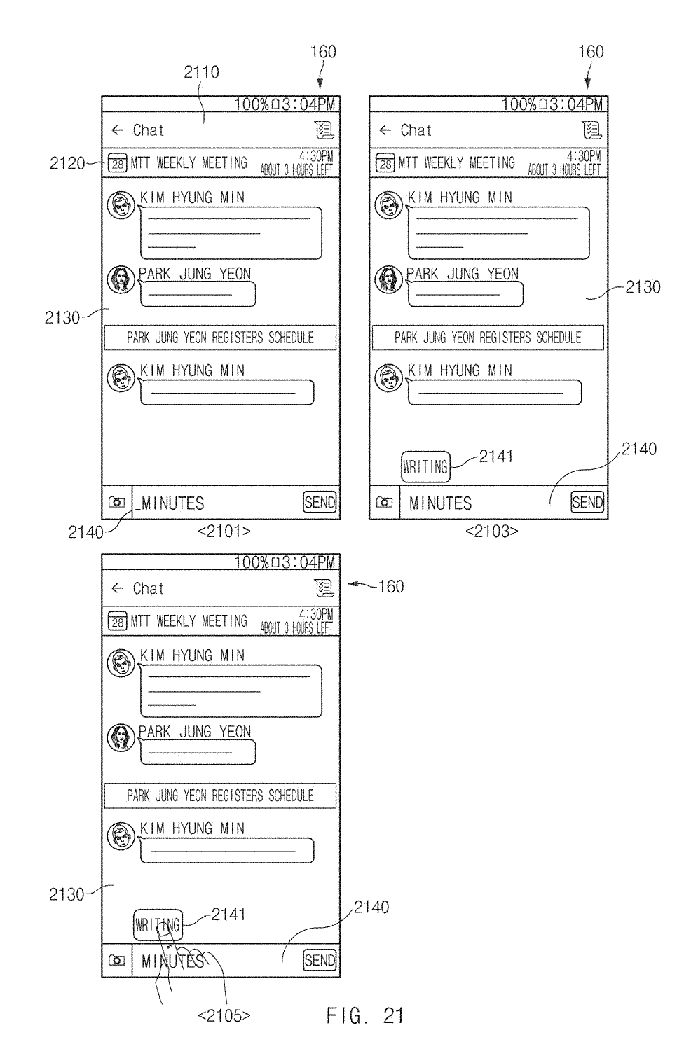

FIG. 21 is a view illustrating an example of a screen interface associated with making minutes, according to an embodiment.

Referring to FIG. 21, as illustrated in state 2101, the electronic device 100 may output a chat room screen in the display 160. For example, a chat room screen may include a title area 2110, a chat room-related information display area 2120, a dialog area 2130, and an input window 2140. A text or the like according to a user input may be output in the input window 2140.

According to an embodiment, if search information such as a specific text, a specified image, or the like is entered in the input window 2140, as illustrated in state 2103, the electronic device 100 may output a function item 2141 associated with the entered search information. For example, the function item 2141 may be a virtual input button corresponding to minutes being search information. The function item 2141 may be output in a specific area (e.g., the dialog area 2130) adjacent to the input window 2140.

As illustrated in state 2105, if the function item 2141 is selected, the electronic device 100 may execute a function set in the function item 2141. For example, the electronic device 100 may make minutes depending on the execution of the function item 2141.

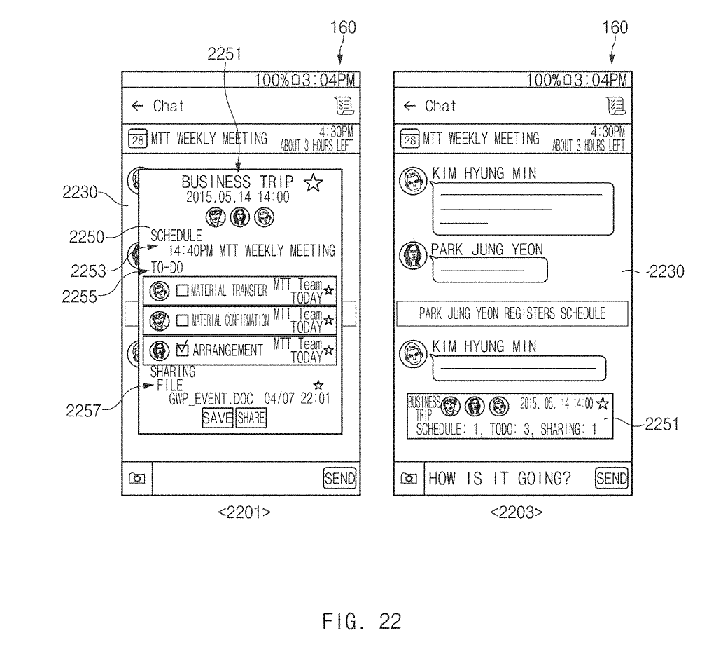

FIG. 22 is a view illustrating an example of a screen interface associated with minute generation, according to an embodiment.

Referring to FIG. 22, the electronic device 100 may generate minutes depending on a minute generating request. According to an embodiment, if an input signal for requesting the generation of minutes occurs, the electronic device 100 may collect dialog information that is transmitted or received in a chat room. The electronic device 100 may extract words, the frequency each of which is not less than a specific frequency, in the transmitted or received dialog information and may generate a title of minutes by combining the extracted words. Alternatively, the electronic device 100 may generate a word, which has the highest frequency, as the title of minutes. According to various embodiments, the electronic device 100 may generate minutes including schedule information, to-do information, or the like that is registered through a chat room. According to an embodiment, as illustrated in state 2201, the electronic device 100 may output a minute window 2250 on a chat room screen (e.g., on a dialog area 2230).

For example, the minute window 2250 may include a meeting title area 2251, a meeting schedule area 2253, a to-do area 2255, and a sharing area 2257. The meeting title area 2251 may be automatically generated based on the transmitted or received dialog content or may be generated in response to a user input to request the generation of minutes. The meeting title area 2251 may include information about the time when minutes are made, chat room participant information, or the like. The meeting schedule area 2253, the to-do area 2255, or the like may be an area in which pieces of information registered in the corresponding chat room within a specific time range are collected and displayed. The sharing area 2257 may be an area in which a list of pieces of file information shared through a chat room is displayed.

If making minutes is completed (e.g., an event to select a virtual storage button occurs) and if a sharing request (e.g., an event to select a virtual sharing button occurs) is generated, as illustrated in state 2203, the electronic device 100 may output a new minute object 2251 in the dialog area 2230. If the new minute object 2251 is selected, as illustrated in state 2201, the electronic device 100 may output the minute window 2250. For example, the new minute object 2251 may include meeting title information, meeting participant information, information about a period in time when minutes are made, or the like. Furthermore, the new minute object 2251 may include a schedule, to-do, information about the number associated with sharing (e.g., a file), or the like.

According to various embodiments, the electronic device 100 may generate one meeting record by collecting the entire content (e.g., the entire dialog, the entire registered schedule, the entire registered to-do, all transmitted or received files, or the like) transmitted or received in a chat room. Alternatively, the electronic device 100 may collect content in a time range (e.g., today or this week) by user designation or at a specified period (e.g., an hour unit, a business hour unit, or the like) to generate one meeting record. Alternatively, the electronic device 100 may generate one meeting record in a specified time range or based on content between the dialog start (a point in time when a new dialog is started after a dialog input is absent during a specific time and then a specific time elapses) and the dialog end (a point in time when a dialog input is absent during a specific time).

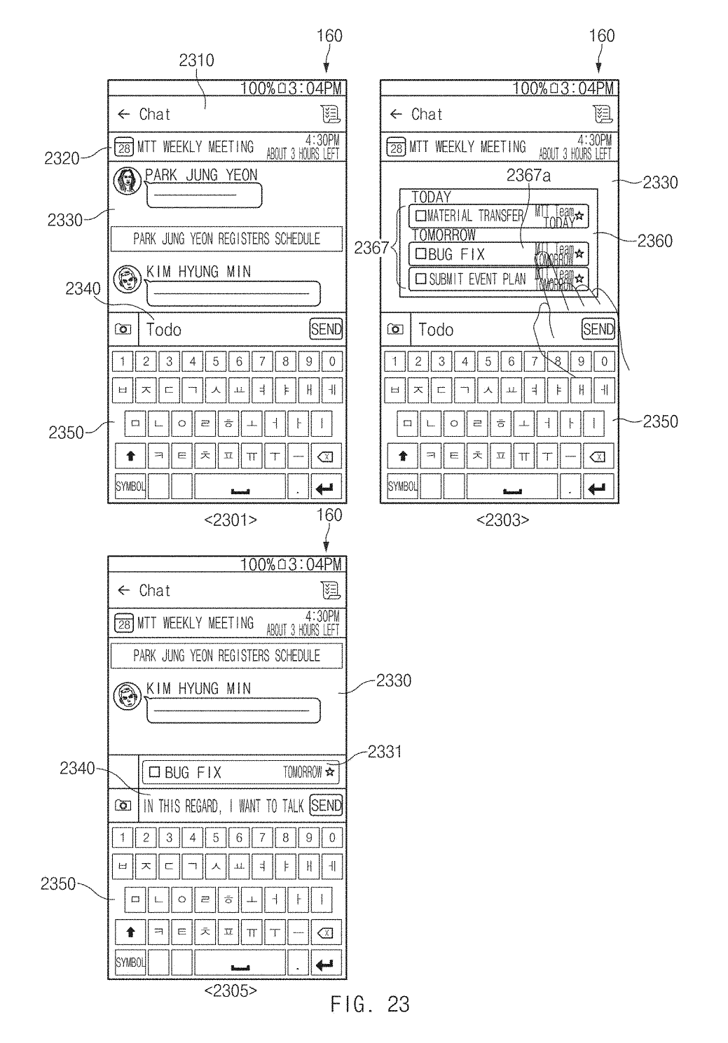

FIG. 23 is a view illustrating an example of a screen interface associated with search processing, according to an embodiment.

Referring to FIG. 23, the electronic device 100 may output a chat room screen in the display 160. For example, a chat room screen may include a title area 2310, a chat room-related information display area 2320, a dialog area 2330, and an input window 2340. According to various embodiments, if an event to select the input window 2340 occurs, as illustrated in state 2301, the electronic device 100 may output a virtual input panel 2350. For example, the virtual input panel 2350 may be output in the display 160 together with the resized dialog area 2330. In response to the selection of a virtual button occurring on the virtual input panel 2350, the electronic device 100 may output the corresponding text as search information in the input window 2340.

According to an embodiment, in the case where specified search information, for example, to-do is entered in the input window 2340, as illustrated in state 2303, the electronic device 100 may output a function window 2360 corresponding to the to-do. For example, the function window 2360 may be output in an area adjacent to the input window 2340. For example, the function window 2360 may include to-do information items 2367. For example, the to-do information items 2367 may correspond to pieces of group to-do information registered the corresponding chat room or may correspond to pieces of to-do information associated with a user entering search information in the input window 2340.

If a specific to-do information item 2367a is selected, as illustrated in state 2305, the electronic device 100 may output to-do information object 2331 corresponding to the specific to-do information item 2367a, in the dialog area 2330. The to-do information object 2331 output to the dialog area 2330 may be identically output in the dialog area of another participant electronic device.

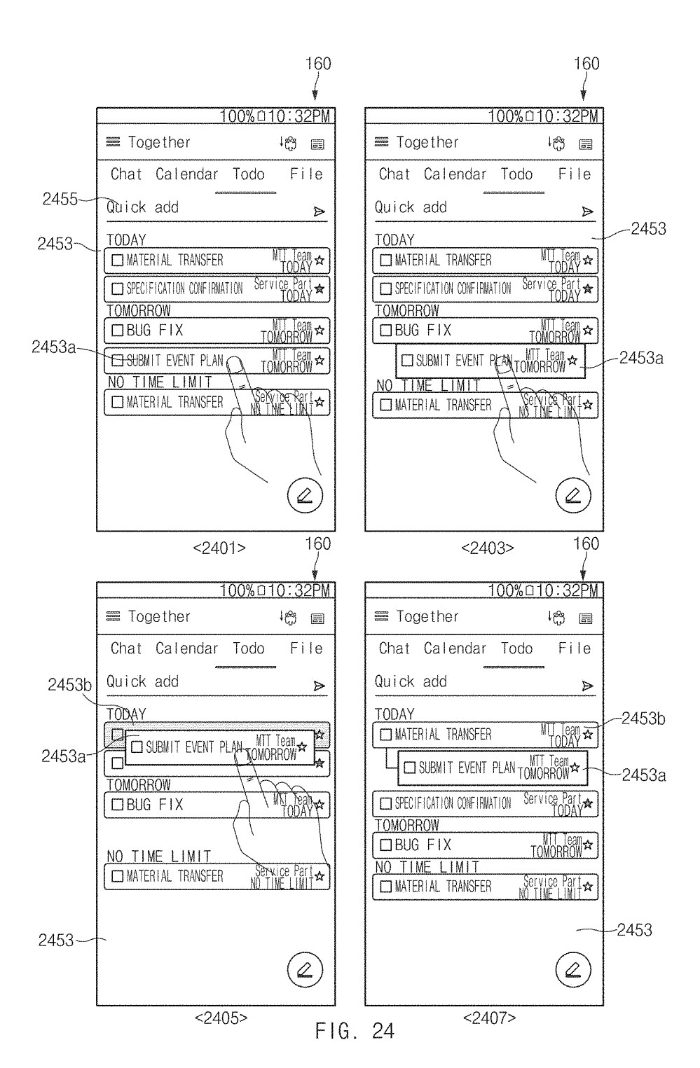

FIG. 24 is a view illustrating an example of a screen interface associated with to-do information arrangement change, according to an embodiment.

Referring to FIG. 24, as illustrated in state 2401, the electronic device 100 may output a to-do information screen associated with all chat rooms in the display 160 in response to the occurrence of a specified input event. For example, the to-do information screen associated with all chat rooms may include an entire to-do information generation area 2455 and an entire to-do information display area 2453.

According to various embodiments, if an input event to select a specific to-do item 2453a is received, as illustrated in state 2403, the electronic device 100 may display a specific to-do item 2453a to be in a floating state (e.g., a state where a layer between the specific to-do item 2453a and the entire to-do information display area 2453 is made different). In this state, the location of the specific to-do item 2453a may be changed in response to a touch movement. For example, as illustrated in state 2405, the specific to-do item 2453a may be overlapped with at least part of other to-do item 2453b. In this state, if a specified touch event (e.g., a touch release event) occurs, the electronic device 100 may arrange the selected specific to-do item 2453a as the sub item of the other to-do item 2453b. In this regard, as illustrated in state 2407, the electronic device 100 may arrange the other to-do item 2453b as an upper depth item and may display the specific to-do item 2453a as the lower depth item of the other to-do item 2453b.

Depending on the above-described settings, since the specific to-do item 2453a belongs to the other to-do item 2453b, the specific to-do item 2453a may be automatically registered in the chat room in which the other to-do item 2453b is registered. The specific to-do item 2453a may be newly registered as the sub item of the other to-do item 2453b in the corresponding chat room list.

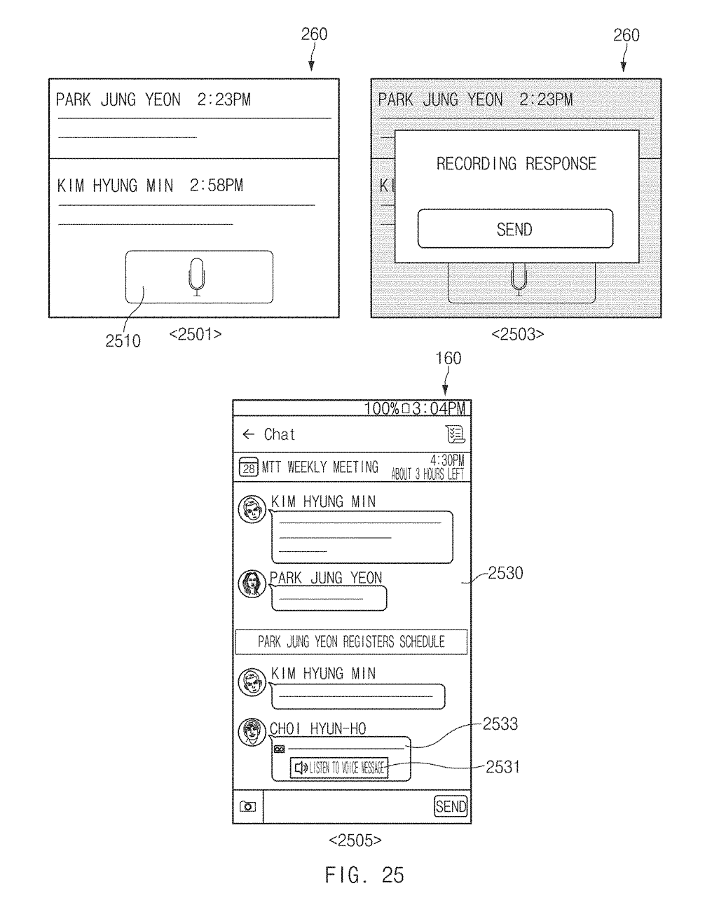

FIG. 25 is a view illustrating an example of a screen interface associated with a chat function operation based on voice information, according to an embodiment.

Referring to FIG. 25, an electronic device may transmit and output pieces of information associated with a chat room operation to the electronic device 100 at a periphery of the electronic device. According to an embodiment, as illustrated in state 2501, a display 260 of a wearable device may output information about a part of recent dialog among the entire chat room information.

According to various embodiments, the display 260 of the wearable device may provide a virtual voice input button 2510. If the virtual voice input button 2510 is selected, as illustrated in state 2503, a voice input may be processed as input information of a chat room. As such, a wearable device, the display area of which is relatively small, may substitute a text input or the like with a voice input.

As illustrated in state 2505, the electronic device 100 receiving the voice input from the wearable device may output a voice input information object 2531 in a dialog area 2530 of a chat room displayed in the display 160. At this time, the electronic device 100 may output text information 2533 corresponding to the voice input information object 2531. The text information 2533 may be generated through a function to convert voice input information into a text. If listening to a voice message is selected, the electronic device 100 may output audio information corresponding to the voice input information.

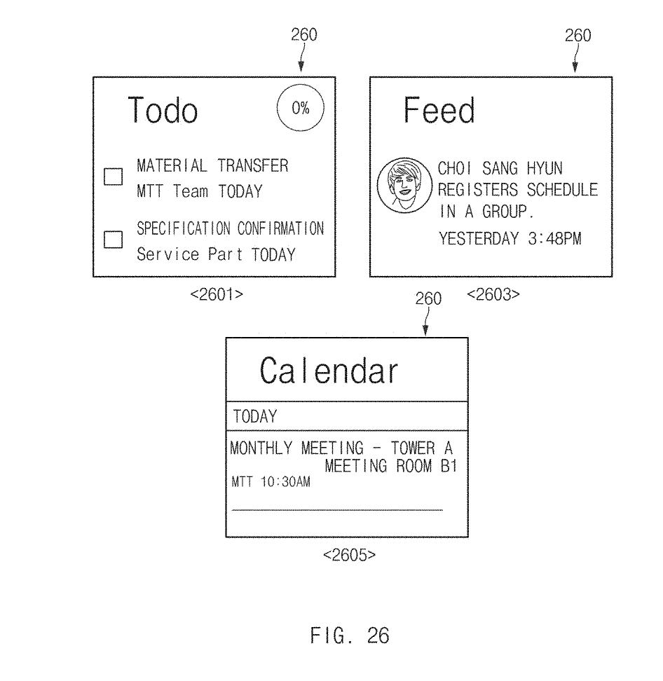

FIG. 26 is a view illustrating an example of a screen interface associated with a job information display in a wearable device, according to an embodiment.

Referring to FIG. 26, a wearable electronic device may output job information based on a chat room in the various forms. For example, as illustrated in state 2601, the display 260 of the wearable electronic device may output to-do information. According to various embodiments, the display 260 of the wearable electronic device may output pieces of recent to-do information (or pieces of to-do information, the importance of which is set to be relatively high) of the specific number among pieces of to-do information. When a scroll event occurs, pieces of to-do information that are not yet displayed may be displayed.

According to various embodiments, as illustrated in state 2603, the display 260 of the wearable electronic device may also output only job information registrations. In this regard, if specific job information is newly registered through a specified chat room, the wearable electronic device may display registered job information. According to various embodiments, as illustrated in state 2605, the display 260 of the wearable electronic device may output calendar information.

According to various embodiments, the wearable electronic device may output a user interface including the above-described to-do information output item, a new job registration verification item, a calendar item, or the like. The wearable electronic device may output a screen such as above-described state 2601, state 2603, or state 2605, in response to item selection of the user interface.

According to various embodiments, an electronic device according to an embodiment may include a housing, a display disposed in one surface of the housing, a processor operatively connected to the display, and a memory operatively connected to the processor. The memory may store instructions, when executed, causing the processor to display a chat room, in which messages transmitted or received between a first user and a second user are included, in at least part of the display, to display a first user interface corresponding to the first user in at least part of the chat room, and to display a window for displaying first information associated with at least one of a schedule, to-do, punctuality, or location of the first user so as to be overlapped with at least part of the chat room, in response to a first user input to select the first user interface.

According to various embodiments, the instructions may cause the processor to display the information in at least part of the window based on the determination that the first information satisfies a selected condition.

According to various embodiments, the selected condition may include whether second information associated with at least one the schedule, the to-do, the punctuality, or the location of the second user is substantially the same as the first information.

According to various embodiments, the instructions may cause the processor to display the first information instead of the window in response to a second user input to drag an area corresponding to the first information in the window and to drop in the outside area of the window in the chat room so as to be overlapped with at least part of the chat room.

According to various embodiments, the instructions may cause the processor to display a third user interface indicating that the first information is information associated with the first user so as to be adjacent to the first information.

According to various embodiments, while the window is displayed to be overlapped with at least part of the chat room, the electronic device is in a first state where a text input is not capable of being received, and while the information instead of the window is displayed to be overlapped with at least part of the chat room, the electronic device is in a second state where a text input is capable of being received.

According to various embodiments, the instructions may cause the processor to transmit the first information to the second user in response to the second user input to drag a first area corresponding to the first information in the window and to drop in a second area corresponding to the second user in the chat room.

According to various embodiments, the instructions may cause the processor to store the first information as second information associated with the second user in response to the second user input to drag a first area corresponding to the first information in the window and to drop in a second area corresponding to the second user in the chat room.

According to various embodiments, an electronic device according to an embodiment may include a housing, a display disposed in one surface of the housing, a processor operatively connected to the display, and a memory operatively connected to the processor. The memory may store instructions, when executed, causing the processor to display a chat room, in which messages transmitted or received between a first user and a second user are included, in at least part of the display, to display a first user interface corresponding to the first user in at least part of the chat room, and to display a second user interface indicating at least part of first information associated with at least one of schedule, to-do, punctuality, or location of the first user so as to be adjacent to the first user interface.

According to various embodiments, the instructions may cause the processor to display the second user interface in a first color if the amount of the first information is large and to display the second user interface in a second color if the amount of the first information is small.

According to various embodiments, the instructions may cause the processor to display the second user interface based on the determination that the first information satisfies a selected condition.

According to various embodiments, the second user interface may include the number, a text, or an icon.

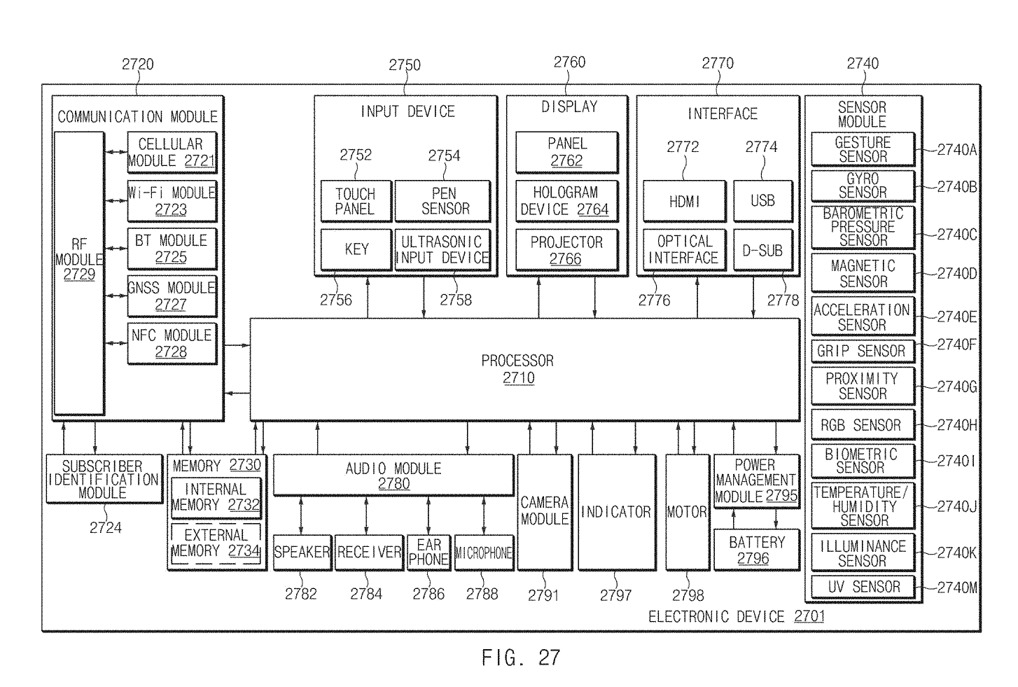

FIG. 27 illustrates a block diagram of an electronic device 2701, according to various embodiments.

The electronic device 2701 may include, for example, all or a part of the electronic device 100 of FIG. 1. The electronic device 2701 may include one or more processors (e.g., an application processor (AP)) 2710, a communication module 2720, a subscriber identification module 2724, a memory 2730, a sensor module 2740, an input device 2750, a display 2760, an interface 2770, an audio module 2780, a camera module 2791, a power management module 2795, a battery 2796, an indicator 2797, and a motor 2798.

The processor 2710 may drive, for example, an operating system (OS) or an application to control a plurality of hardware or software elements connected to the processor 2710 and may process and compute a variety of data. For example, the processor 2710 may be implemented with a System on Chip (SoC). According to an embodiment, the processor 2710 may further include a graphic processing unit (GPU) and/or an image signal processor. The processor 2710 may load a command or data, which is received from at least one of other elements (e.g., a nonvolatile memory), into a volatile memory and process the loaded command or data. The processor 2710 may store a variety of data in the nonvolatile memory.

The communication module 2720 may include the cellular module 2721, a Wi-Fi module 2723, a Bluetooth (BT) module 2725, a GNSS module 2727 (e.g., a GPS module, a Glonass module, a Beidou module, or a Galileo module), a near field communication (NFC) module 2728, and a radio frequency (RF) module 2729.

The cellular module 2721 may provide, for example, voice communication, video communication, a character service, an Internet service, or the like over a communication network. According to an embodiment, the cellular module 2721 may perform discrimination and authentication of the electronic device 2701 within a communication network by using the subscriber identification module (e.g., a SIM card) 2724. According to an embodiment, the cellular module 2721 may perform at least a portion of functions that the processor 2710 provides. According to an embodiment, the cellular module 2721 may include a communication processor (CP).

Each of the Wi-Fi module 2723, the BT module 2725, the GNSS module 2727, or the NFC module 2728 may include a processor for processing data exchanged through a corresponding module, for example. According to an embodiment, at least a part (e.g., two or more) of the cellular module 2721, the Wi-Fi module 2723, the BT module 2725, the GNSS module 2727, or the NFC module 2728 may be included within one Integrated Circuit (IC) or an IC package.

For example, the RF module 2729 may transmit and receive a communication signal (e.g., an RF signal). For example, the RF module 2729 may include a transceiver, a power amplifier module (PAM), a frequency filter, a low noise amplifier (LNA), an antenna, or the like. According to another embodiment, at least one of the cellular module 2721, the Wi-Fi module 2723, the BT module 2725, the GNSS module 2727, or the NFC module 2728 may transmit and receive an RF signal through a separate RF module.

The subscriber identification module 2724 may include, for example, a card and/or embedded SIM that includes a subscriber identification module and may include unique identify information (e.g., integrated circuit card identifier (ICCID)) or subscriber information (e.g., integrated mobile subscriber identity (MI)).

The memory 2730 may include, for example, an internal memory 2732 or an external memory 2734. For example, the internal memory 2732 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 2734 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 2734 may be operatively and/or physically connected to the electronic device 2701 through various interfaces.

The sensor module 2740 may measure, for example, a physical quantity or may detect an operation state of the electronic device 2701. The sensor module 2740 may convert the measured or detected information to an electric signal. For example, the sensor module 2740 may include at least one of a gesture sensor 2740A, a gyro sensor 2740B, a barometric pressure sensor 2740C, a magnetic sensor 2740D, an acceleration sensor 2740E, a grip sensor 2740F, the proximity sensor 2740G, a color sensor 2740H (e.g., red, green, blue (RGB) sensor), a biometric sensor 2740I, a temperature/humidity sensor 2740J, an illuminance sensor 2740K, or an UV sensor 2740M. Although not illustrated, additionally or alternatively, the sensor module 2740 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 2740 may further include a control circuit for controlling at least one or more sensors included therein. According to an embodiment, the electronic device 2701 may further include a processor that is a part of the processor 2710 or independent of the processor 2710 and is configured to control the sensor module 2740. The processor may control the sensor module 2740 while the processor 2710 remains at a sleep state.

The input device 2750 may include, for example, a touch panel 2752, a (digital) pen sensor 2754, a key 2756, or an ultrasonic input unit 2758. For example, the touch panel 2752 may use at least one of capacitive, resistive, infrared and ultrasonic detecting methods. Also, the touch panel 2752 may further include a control circuit. The touch panel 2752 may further include a tactile layer to provide a tactile reaction to a user.

The (digital) pen sensor 2754 may be, for example, a part of a touch panel or may include an additional sheet for recognition. The key 2756 may include, for example, a physical button, an optical key, a keypad, or the like. The ultrasonic input device 2758 may detect (or sense) an ultrasonic signal, which is generated from an input device, through a microphone (e.g., a microphone 2788) and may check data corresponding to the detected ultrasonic signal.

The display 2760 (e.g., the display 160) may include a panel 2762, a hologram device 2764, or a projector 2766. The panel 2762 may be implemented, for example, to be flexible, transparent or wearable. The panel 2762 and the touch panel 2752 may be integrated into a single module. The hologram device 2764 may display a stereoscopic image in a space using a light interference phenomenon. The projector 2766 may project light onto a screen so as to display an image. For example, the screen may be arranged in the inside or the outside of the electronic device 2701. According to an embodiment, the display 2760 may further include a control circuit for controlling the panel 2762, the hologram device 2764, or the projector 2766.

The interface 2770 may include, for example, a high-definition multimedia interface (HDMI) 2772, a universal serial bus (USB) 2774, an optical interface 2776, or a D-subminiature (D-sub) 2778. Additionally or alternatively, the interface 2770 may include, for example, a mobile high definition link (MHL) interface, a SD card/multi-media card (MMC) interface, or an infrared data association (IrDA) standard interface.

The audio module 2780 may convert a sound and an electric signal in dual directions. The audio module 2780 may process, for example, sound information that is input or output through a speaker 2782, a receiver 2784, an earphone 2786, or the microphone 2788.

For example, the camera module 2791 may shoot a still image or a video. According to an embodiment, the camera module 2791 may include at least one or more image sensors (e.g., a front sensor or a rear sensor), a lens, an image signal processor (ISP), or a flash (e.g., an LED or a xenon lamp).

The power management module 2795 may manage, for example, power of the electronic device 2701. According to an embodiment, a power management integrated circuit (PMIC), a charger IC, or a battery or fuel gauge may be included in the power management module 2795. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 2796 and a voltage, current or temperature thereof while the battery is charged. The battery 2796 may include, for example, a rechargeable battery and/or a solar battery.

The indicator 2797 may display a specific state of the electronic device 2701 or a part thereof (e.g., the processor 2710), such as a booting state, a message state, a charging state, and the like. The motor 2798 may convert an electrical signal into a mechanical vibration and may generate the following effects: vibration, haptic, and the like. Although not illustrated, a processing device (e.g., a GPU) for supporting a mobile TV may be included in the electronic device 2701. The processing device for supporting the mobile TV may process media data according to the standards of digital multimedia broadcasting (DMB), digital video broadcasting (DVB), MediaFlo™, or the like.

Each of the above-mentioned elements of the electronic device according to various embodiments of the present disclosure may be configured with one or more components, and the names of the elements may be changed according to the type of the electronic device. In various embodiments, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

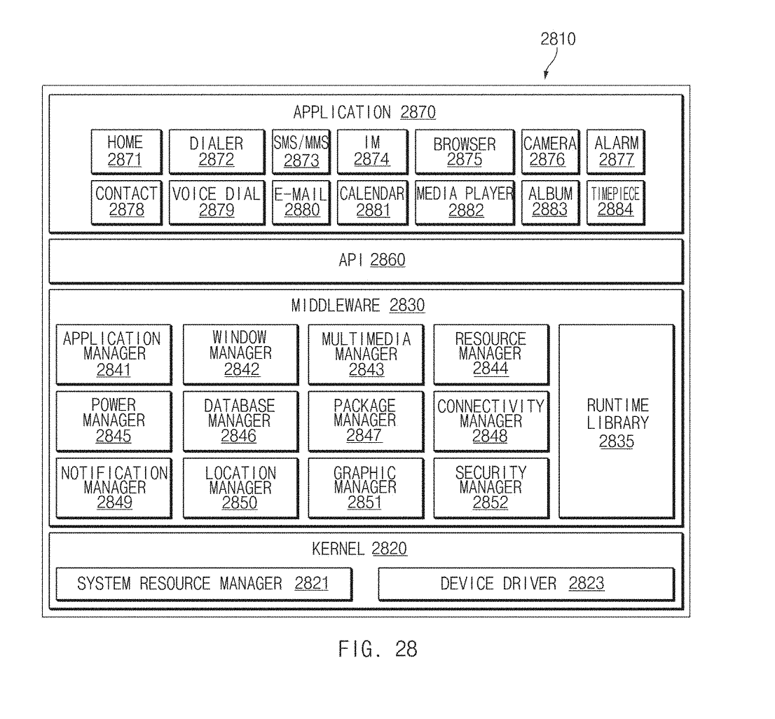

FIG. 28 is a block diagram of a program module, according to various embodiments.

According to an embodiment, a program module 2810 may include an operating system (OS) to control resources associated with an electronic device (e.g., the electronic device 100 or the electronic device 1401), and/or diverse applications (e.g., the application program 147) driven on the OS. The OS may be, for example, Android, iOS, Windows, Symbian, Tizen, or Bada.

The program module 2810 may include a kernel 2820, a middleware 2830, an application programming interface (API) 2860, and/or an application 2870. At least a portion of the program module 2810 may be preloaded on an electronic device or may be downloadable from an external electronic device.

The kernel 2820 may include, for example, a system resource manager 2821 and/or a device driver 2823. The system resource manager 2821 may perform control, allocation, or retrieval of system resources. According to an embodiment, the system resource manager 2821 may include a process managing unit, a memory managing unit, or a file system managing unit. The device driver 2823 may include, for example, a display driver, a camera driver, a Bluetooth driver, a shared memory driver, a USB driver, a keypad driver, a Wi-Fi driver, an audio driver, or an inter-process communication (IPC) driver.

The middleware 2830 may provide, for example, a function that the application 2870 needs in common, or may provide diverse functions to the application 2870 through the API 2860 to allow the application 2870 to efficiently use limited system resources of the electronic device. According to an embodiment, the middleware 2830 may include at least one of a runtime library 2835, an application manager 2841, a window manager 2842, a multimedia manager 2843, a resource manager 2844, a power manager 2845, a database manager 2846, a package manager 2847, a connectivity manager 2848, a notification manager 2849, a location manager 2850, a graphic manager 2851, or a security manager 2852.

The runtime library 2835 may include, for example, a library module that is used by a compiler to add a new function through a programming language while the application 2870 is being executed. The runtime library 2835 may perform input/output management, memory management, or capacities about arithmetic functions.

The application manager 2841 may manage, for example, a life cycle of at least one application of the application 2870. The window manager 2842 may manage a graphic user interface (GUI) resource that is used in a screen. The multimedia manager 2843 may identify a format necessary for playing diverse media files, and may perform encoding or decoding of media files by using a codec suitable for the format. The resource manager 2844 may manage resources such as a storage space, memory, or source code of at least one application of the application 2870.

The power manager 2845 may operate, for example, with a basic input/output system (BIOS) to manage a battery or power, and may provide power information for an operation of an electronic device. The database manager 2846 may generate, search for, or modify database that is to be used in at least one application of the application 2870. The package manager 2847 may install or update an application that is distributed in the form of package file.

The connectivity manager 2848 may manage, for example, wireless connection such as Wi-Fi or Bluetooth. The notification manager 2849 may display or notify an event such as arrival message, appointment, or proximity notification in a mode that does not disturb a user. The location manager 2850 may manage location information about an electronic device. The graphic manager 2851 may manage a graphic effect that is provided to a user, or manage a user interface relevant thereto. The security manager 2852 may provide a general security function necessary for system security, user authentication, or the like. According to an embodiment, in the case where an electronic device (e.g., the electronic device 100 or the electronic device 1301) includes a telephony function, the middleware 2830 may further include a telephony manager for managing a voice or video call function of the electronic device.

The middleware 2830 may include a middleware module that combines diverse functions of the above-described elements. The middleware 2830 may provide a module specialized to each OS kind to provide differentiated functions. Additionally, the middleware 2830 may dynamically remove a part of the preexisting elements or may add new elements thereto.

The API 2860 (e.g., the API 145) may be, for example, a set of programming functions and may be provided with a configuration that is variable depending on an OS.

For example, in the case where an OS is Android or iOS, it may provide one API set per platform. In the case where an OS is Tizen, it may provide two or more API sets per platform.

The application 2870 may include, for example, one or more applications capable of providing functions for a home 2871, a dialer 2872, an SMS/MMS 2873, an instant message (IM) 2874, a browser 2875, a camera 2876, an alarm 2877, a contact 2878, a voice dial 2879, an e-mail 2880, a calendar 2881, a media player 2882, an album 2883, or a timepiece 2884 or for offering health care (e.g., measuring an exercise quantity, blood sugar, or the like) or environment information (e.g., information of barometric pressure, humidity, temperature, or the like).

According to an embodiment, the application 2870 may include an application (hereinafter referred to as “information exchanging application” for descriptive convenience) to support information exchange between an electronic device (e.g., the electronic device 101) and an external electronic device (e.g., the first electronic device 102 or the second electronic device 104). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device. Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of elements) or adjustment of brightness (or resolution) of a display) of the external electronic device which communicates with the electronic device, an application running in the external electronic device, or a service (e.g., a call service, a message service, or the like) provided from the external electronic device.

According to an embodiment, the application 2870 may include an application (e.g., a health care application of a mobile medical device) that is assigned in accordance with an attribute of an external electronic device. According to an embodiment, the application 2870 may include an application that is received from an external electronic device. According to an embodiment, the application 2870 may include a preloaded application or a third party application that is downloadable from a server. The names of elements of the program module 2810 according to the embodiment may be modifiable depending on kinds of operating systems.

According to various embodiments, at least a portion of the program module 2810 may be implemented by software, firmware, hardware, or a combination of two or more thereof. At least a portion of the program module 2810 may be implemented (e.g., executed), for example, by the processor (e.g., the processor 120, the processor 20, the processor 1410). At least a portion of the program module 2810 may include, for example, modules, programs, routines, sets of instructions, processes, or the like for performing one or more functions.

The term “module” used in this disclosure may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 120), may cause the one or more processors to perform a function corresponding to the instruction. The computer-readable storage media, for example, may be the memory 130.

A computer-readable recording medium may include a hard disk, a floppy disk, a magnetic media (e.g., a magnetic tape), an optical media (e.g., a compact disc read only memory (CD-ROM) and a digital versatile disk (DVD), a magneto-optical media (e.g., a floptical disk)), and hardware devices (e.g., a read only memory (ROM), a random access memory (RAM), or a flash memory). Also, the one or more instructions may contain a code made by a compiler or a code executable by an interpreter. The above hardware unit may be configured to operate via one or more software modules for performing an operation according to various embodiments, and vice versa.

A module or a program module according to various embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a housing;
a display disposed in one surface of the housing;
a processor operatively connected to the display; and
a memory operatively connected to the processor,
wherein the memory stores instructions, when executed, causing the processor to:
display a chat room, in which a plurality of users participate, in at least part of the display;
display identification information associated with at least one user selected among the plurality of users, in at least part of the chat room; and
display a window associated with job information of the selected at least one user so as to be overlapped with at least part of the chat room, in response to a user input to select the identification information.

2. The electronic device of claim 1, wherein the job information includes at least one of schedule information, to-do information, or file information.

3. The electronic device of claim 1, wherein the instructions further causing the processor to:
generate new job information of the at least one user in response to another user input; and
register the new job information as at least part of the job information of the at least one user.

4. The electronic device of claim 3, wherein the instructions further causing the processor to:
activate or deactivate an area, which is associated with new job information and which is capable of generating the new job information on a window, depending on a rating or settings of the at least one user.

5. The electronic device of claim 1, wherein the instructions further causing the processor to:
register the job information of the at least one user as job information of a group of the plurality of users in response to another user input; and
display the job information of the at least one user in the at least part of the chat room in response to the another user input.

6. The electronic device of claim 1, wherein the memory stores interest information of a user of the electronic device, and
wherein the instructions further causing the processor to:
store a list or job information selected from a dialog list displayed in the chat room or the job information of the at least one user, as at least part of the interest information.

7. The electronic device of claim 1, further comprising:
a communication circuit,
wherein the instructions further causing the processor to:
transmit a request to register job information selected from the job information of the at least one user as job information of at least another user among the plurality of users, to an external device by using the communication circuit in response to another user input.

8. The electronic device of claim 7, wherein the instructions further causing the processor to:
if at least one condition associated with the chat room satisfies a specified condition, transmit the request to the external device.

9. The electronic device of claim 8, wherein the at least one condition includes whether the another user input is received within a time of a specified range,
wherein the instructions further causing the processor to:
if the another user input is received within the time of the specified range, transmit the request to the external device; and
if the another user input is received out of the time of the specified range, display a notification associated with impossibility of the request so as to be overlapped with the at least part of the chat room.

10. A job information processing method, the method comprising:
displaying a chat room, in which a plurality of users participate, in at least part of a display;
displaying identification information associated with at least one user selected among the plurality of users, in at least part of the chat room; and
displaying a window associated with job information of the selected at least one user so as to be overlapped with the at least part of the chat room, in response to a user input to select the identification information.

11. The method of claim 10, wherein the job information includes at least one of schedule information, to-do information, or file information.

12. The method of claim 10, further comprising:
storing a list or job information selected from a dialog list displayed in the chat room or the job information of the at least one user, as at least part of the interest information of a specified list form.

13. The method of claim 10, further comprising:
receiving another user input;
generating new job information of the at least one user and registering the new job information as at least part of the job information of the at least one user, in response to the another user input;
registering the job information of the at least one user as job information of a group of the plurality of users in response to the another user input; and
displaying the job information of the at least one user in the at least part of the chat room in response to the another user input.
transmitting a request to register job information selected from the job information of the at least one user as job information of at least another user of the plurality of users, to an external device in response to the another user input.

14. The method of claim 13, further comprising:
activating or deactivating an area, which is associated with new job information and which is capable of generating the new job information on a window, depending on a rating or settings of the at least one user.

15. The method of claim 13, further comprising:
if at least one condition associated with the chat room satisfies a specified condition, transmitting the request to the external device;
determining whether the another user input is received within a time of a specified range; if the another user input is received within the time of the specified range, transmitting the request to the external device; and if the another user input is received out of the time of the specified range, displaying a notification associated with impossibility of the request so as to be overlapped with the at least part of the chat room.
